(19) United States
(12) Patent Application Publication
(10) Pub. No.: US 2024/0116003 A1
(43) Pub. Date: Apr. 11, 2024

(54) SPIRAL-WOUND FILTRATION ELEMENT CONFIGURATIONS

(71) Applicant: Donaldson Company, Inc., Bloomington, MN (US)

(72) Inventors: David D. Lauer, Bloomington, MN (US); Benjamin C. Druecke, Hudson, WI (US); David A. Olson, Minneapolis, MN (US); Connor J. Colling, Minneapolis, MN (US); Davis B. Moravec, Burnsville, MN (US); Matthew P. Goertz, Bloomington, MN (US); Nicholas J. Stanley, Bloomington, MN (US); Robert P. McCollam, Vadnais Heights, MN (US)

(21) Appl. No.: 18/375,010

(22) Filed: Sep. 29, 2023

Related U.S. Application Data
(60) Provisional application No. 63/412,801, filed on Oct. 3, 2022.

(51) Int. Cl. B01D 63/10

(52) U.S. Cl. CPC B01D 63/106; B01D 2313/14

(57) ABSTRACT

Embodiments herein relate to filtration devices having spiral wound filtration element. In an embodiment, a filtration device is included having a first spiral wound filter element. The first spiral wound filter element can include one or more spacing layers, one or more membrane layers disposed in between the one or more spacing layers, and a plurality of spacing elements. The first spiral wound filter element can have an aspect ratio that is less than 8:1 height to width. Other embodiments are also included herein.

This application claims the benefit of U.S. Provisional Application No. 63/412,801, filed Oct. 3, 2022, the content of which is herein incorporated by reference in its entirety.

### FIELD

Embodiments herein relate to spiral-wound filtration element configuration.

### BACKGROUND

Filter elements help to separate solids from liquids and gases and remove any impurities or contaminates that could be present. Filter elements are desirable for many applications including purifying chemicals and pharmaceuticals, preventing cross-contamination, health hazards, and environmental issues, protecting industrial equipment, beverage clarification including beer clarification, and providing safe drinking water, agricultural irrigation, swimming pools, and aquariums.

Many filter elements include spacing screens or spacing elements designed to provide separation of various medias such as filter medias, depth loading medias, surface loading medias, medias with adsorbents, and functionalized medias for targeted capture of contaminants and/or desirable species. Although various filter elements exist, there remains a need for improved spacing screens, spacing elements, and filtration elements.

### SUMMARY

In a first aspect, a filtration device is included having a first spiral wound filter element. The first spiral wound filter element has one or more spacing layers, one or more membrane layers disposed in between the one or more spacing layers, and a plurality of spacing elements, wherein the aspect ratio of the first spiral wound filter element is less than 8:1 height to width.

In a second aspect, in addition to one or more of the preceding or following aspects, or in the alternative to some aspects, the filtration device includes a second, third, and fourth spiral wound filter element, wherein the second, third, and fourth spiral wound filter elements each include: one or more spacing layers, one or more membrane layers disposed in between the one or more spacing layers, and a plurality of spacing elements, wherein the aspect ratio of the second, third, and fourth spiral wound filter elements is less than 8:1 height to width.

In a third aspect, in addition to one or more of the preceding or following aspects, or in the alternative to some aspects, the filtration device includes a fifth, sixth, seventh, and eighth spiral wound filter element, wherein the fifth, sixth, seventh, and eighth spiral wound filter elements each include: one or more spacing layers, one or more membrane layers disposed in between the one or more spacing layers, and a plurality of spacing elements, wherein the aspect ratio of the fifth, sixth, seventh, and eighth spiral wound filter elements is less than 8:1 height to width.

In a fourth aspect, in addition to one or more of the preceding or following aspects, or in the alternative to some aspects, the filtration device further includes a first stack including the first, second, third and fourth spiral wound filter elements placed in parallel.

In a fifth aspect, in addition to one or more of the preceding or following aspects, or in the alternative to some aspects, the filtration device further includes a first stack including the first, second, third and fourth spiral wound filter elements placed in parallel, the filtration device further includes a second stack including the fifth, sixth, seventh, and eighth spiral wound filter elements placed in parallel.

In a sixth aspect, in addition to one or more of the preceding or following aspects, or in the alternative to some aspects, the first stack and the second stack are placed in series.

In a seventh aspect, in addition to one or more of the preceding or following aspects, or in the alternative to some aspects, the filtration device has a height between two and ten inches.

In an eighth aspect, in addition to one or more of the preceding or following aspects, or in the alternative to some aspects, the height of the filtration device is between three and four inches.

In a ninth aspect, in addition to one or more of the preceding or following aspects, or in the alternative to some aspects, the height of the filtration device is between four and five inches.

In a tenth aspect, in addition to one or more of the preceding or following aspects, or in the alternative to some aspects, the filtration device has a diameter between 5 to 40 inches.

In an eleventh aspect, in addition to one or more of the preceding or following aspects, or in the alternative to some aspects, the diameter of the filtration device is between 10 and 24 inches.

In a twelfth aspect, in addition to one or more of the preceding or following aspects, or in the alternative to some aspects, the plurality of spacing elements is disposed on one or more sides of the one or more spacing layers.

In a thirteenth aspect, in addition to one or more of the preceding or following aspects, or in the alternative to some aspects, the plurality of spacing elements is disposed on one or more sides of the one or more membrane layers.

In a fourteenth aspect, in addition to one or more of the preceding or following aspects, or in the alternative to some aspects, the filtration device further includes one or more supporting layers disposed in between the one or more membrane layers and the one or more spacing layers.

In a fifteenth aspect, in addition to one or more of the preceding or following aspects, or in the alternative to some aspects, the plurality of spacing elements is arranged in columns and rows.

In a sixteenth aspect, in addition to one or more of the preceding or following aspects, or in the alternative to some aspects, the plurality of spacing elements is arranged in diagonal columns, straight columns, or offset rows.

In a seventeenth aspect, in addition to one or more of the preceding or following aspects, or in the alternative to some aspects, the plurality of spacing elements includes a variety of shapes including one or more of the following: air foils, triangles, rhombuses, parallelograms, trapezoids, kites, trapeziums, pentagons, heptagons, octagons, hexagon, circles, ovals, squares, rectangles, and teardrops.

In an eighteenth aspect, in addition to one or more of the preceding or following aspects, or in the alternative to some aspects, the plurality of spacing elements includes a teardrop shape.

In a nineteenth aspect, in addition to one or more of the preceding or following aspects, or in the alternative to some aspects, the plurality of spacing elements includes an airfoil shape.

In a twentieth aspect, in addition to one or more of the preceding or following aspects, or in the alternative to some aspects, each of the plurality of circular spacing elements includes varying circumferences.

In a twenty-first aspect, in addition to one or more of the preceding or following aspects, or in the alternative to some aspects, the shape of the plurality of spacing elements arranged along an edge portion of the one or more spacing layers is different than the shape of the plurality of spacing elements disposed on a remaining portion of the one or more spacing layers.

In a twenty-second aspect, in addition to one or more of the preceding or following aspects, or in the alternative to some aspects, the shape of the plurality of spacing elements arranged along an edge portion of the one or more membrane layers is different than the shape of the plurality of spacing elements disposed on a remaining portion of the one or more membrane layers.

In a twenty-third aspect, in addition to one or more of the preceding or following aspects, or in the alternative to some aspects, the plurality of spacing elements is arranged in a size gradient.

In a twenty-fourth aspect, in addition to one or more of the preceding or following aspects, or in the alternative to some aspects, the plurality of spacing elements is symmetrically distributed.

In a twenty-fifth aspect, in addition to one or more of the preceding or following aspects, or in the alternative to some aspects, the plurality of spacing elements is unsymmetrically distributed.

In a twenty-sixth aspect, in addition to one or more of the preceding or following aspects, or in the alternative to some aspects, the plurality of spacing elements is formed using three-dimensional printing.

In a twenty-seventh aspect, in addition to one or more of the preceding or following aspects, or in the alternative to some aspects, the plurality of spacing elements is made of one or more of UV curing epoxies, UV curing urethanes, thermoplastic polymers, or silicone polymers.

In a twenty-eighth aspect, in addition to one or more of the preceding or following aspects, or in the alternative to some aspects, the plurality of spacing elements is made of one or more of polydimethylsiloxane or UV curing polydimethylsiloxane.

In a twenty-ninth aspect, in addition to one or more of the preceding or following aspects, or in the alternative to some aspects, the plurality of spacing element is made of one or more of a polyamide, polypropylene, polyurethane, polyethylene, polylactic acid, acrylonitrile butadiene styrene, styrene, or mixtures thereof.

In a thirtieth aspect, in addition to one or more of the preceding or following aspects, or in the alternative to some aspects, the filtration device further includes a core, wherein the one or more spiral wound filter elements are configured to wrap around the core.

In a thirty-first aspect, in addition to one or more of the preceding or following aspects, or in the alternative to some aspects, the core is hollow.

In a thirty-second aspect, in addition to one or more of the preceding or following aspects, or in the alternative to some aspects, the core is solid.

In a thirty-third aspect, in addition to one or more of the preceding or following aspects, or in the alternative to some aspects, the core is made of one or more of a polymer, a metal, or a composite.

In a thirty-fourth aspect, in addition to one or more of the preceding or following aspects, or in the alternative to some aspects, the core has a height between two and nine inches.

In a thirty-fifth aspect, in addition to one or more of the preceding or following aspects, or in the alternative to some aspects, the height of the core is between three and four inches.

In a thirty-sixth aspect, in addition to one or more of the preceding or following aspects, or in the alternative to some aspects, the height of the core is between four and five inches.

In a thirty-seventh aspect, in addition to one or more of the preceding or following aspects, or in the alternative to some aspects, the core has a diameter of less than one inch.

In a thirty-eighth aspect, in addition to one or more of the preceding or following aspects, or in the alternative to some aspects, the core has a diameter between one and four inches.

In a thirty-ninth aspect, in addition to one or more of the preceding or following aspects, or in the alternative to some aspects, the filtration device further includes an impermeable outer wrap configured to wrap around the one or more spiral wound filter elements.

In a fortieth aspect, in addition to one or more of the preceding or following aspects, or in the alternative to some aspects, the one or more membrane layers is made of one or more of cellulose, cellulose with thermoplastic resins, cellulose with thermoset resins, thermoset resins, thermoplastic resins, or thermoplastic resins.

In a forty-first aspect, in addition to one or more of the preceding or following aspects, or in the alternative to some aspects, the one or more membrane layers is made of one or more of polyethersulfone, polytetrafluoroethylene, cellulose acetate, polyvinylidene fluoride, polysulphone, nylon, polypropylene, polyethylene, and polyester.

In a forty-second aspect, in addition to one or more of the preceding or following aspects, or in the alternative to some aspects, the one or more membrane layers is made of polypropylene.

In a forty-third aspect, in addition to one or more of the preceding or following aspects, or in the alternative to some aspects, the one or more membrane layers has an unwound length of between 50 and 450 feet.

In a forty-fourth aspect, in addition to one or more of the preceding or following aspects, or in the alternative to some aspects, the unwound length of the one or more membrane layers is approximately 200 feet.

In a forty-fifth aspect, in addition to one or more of the preceding or following aspects, or in the alternative to some aspects, the one or more membrane layers has a width between two and eight inches.

In a forty-sixth aspect, in addition to one or more of the preceding or following aspects, or in the alternative to some aspects, the width of the one or more membrane layers is four inches.

In a forty-seventh aspect, in addition to one or more of the preceding or following aspects, or in the alternative to some aspects, the one or more membrane layers has a thickness between 50 and 1000 microns.

In a forty-eighth aspect, in addition to one or more of the preceding or following aspects, or in the alternative to some aspects, an adhesive is applied along a length of each the one or more spacing layers and each of the one or more membrane layers, wherein the adhesive is configured to attach each of the one or more spacing layers to each of the one or more membrane layers.

In a forty-ninth aspect, in addition to one or more of the preceding or following aspects, or in the alternative to some aspects, the adhesive is applied along a width between ⅛ inch and 1 inch of each of the one or more spacing layers and each of the one or more membrane layers.

In a fiftieth aspect, a filtration device includes a spiral wound filter element. The spiral wound filter element includes one or more spacing screens having flow direction fibers and cross flow direction fibers, wherein the flow direction fibers are approximately oriented in the flow direction of a fluid entering the spiral wound filter element, and one or more membrane layers disposed in between the one or more spacing screens.

In a fifty-first aspect, in addition to one or more of the preceding or following aspects, or in the alternative to some aspects, the filtration device has an aspect ratio of less than 3:1 height to width.

In a fifty-second aspect, in addition to one or more of the preceding or following aspects, or in the alternative to some aspects, the filtration device has an aspect ratio of less than 10.5:1 height to width.

In a fifty-third aspect, in addition to one or more of the preceding or following aspects, or in the alternative to some aspects, the filtration device has an aspect ratio of less than 12:1.5 height to width.

In a fifty-fourth aspect, in addition to one or more of the preceding or following aspects, or in the alternative to some aspects, the one or more spacing screens is made of a polymer, a metal, or a composite.

In a fifty-fifth aspect, in addition to one or more of the preceding or following aspects, or in the alternative to some aspects, the one or more spacing screens is made of thermoplastic polymers including one or more of polypropylene, high-density polyethylene, polyester, nylon, or polyphenylene sulfide.

In a fifty-sixth aspect, in addition to one or more of the preceding or following aspects, or in the alternative to some aspects, the one or more spacing screens includes one or more coatings, the coatings include an antifouling coating, a conductive coating for electrostatic discharge, and a coating containing sorbents to target specific contaminants.

In a fifty-seventh aspect, in addition to one or more of the preceding or following aspects, or in the alternative to some aspects, the flow direction fibers and the cross flow direction fibers include a variety of shapes can include one or more of the following: circular, polygonal, oval, lima bean shaped, triangular, trilobal, lobular, mushroom shaped, dog-boned shaped, ribbon-shaped, star shaped, and tubular.

In a fifty-eighth aspect, in addition to one or more of the preceding or following aspects, or in the alternative to some aspects, the flow direction fibers are between 100 to 500 microns large.

In a fifty-ninth aspect, in addition to one or more of the preceding or following aspects, or in the alternative to some aspects, the flow direction fibers are 450 microns large.

In a sixtieth aspect, in addition to one or more of the preceding or following aspects, or in the alternative to some aspects, the cross flow direction fibers are between 50 to 300 microns large.

In a sixty-first aspect, in addition to one or more of the preceding or following aspects, or in the alternative to some aspects, the cross flow direction fibers are 50 microns large.

In a sixty-second aspect, in addition to one or more of the preceding or following aspects, or in the alternative to some aspects, wherein the flow direction fibers are larger than the cross flow direction fibers.

In a sixty-third aspect, in addition to one or more of the preceding or following aspects, or in the alternative to some aspects, the one or more spacing screens have a thickness between 100 and 1000 microns.

In a sixty-fourth aspect, in addition to one or more of the preceding or following aspects, or in the alternative to some aspects, the thickness of the one or more spacing screens is between 500 and 700 microns.

In a sixty-fifth aspect, in addition to one or more of the preceding or following aspects, or in the alternative to some aspects, the one or more spacing screens have between 10 and 90 percent open area.

In a sixty-sixth aspect, in addition to one or more of the preceding or following aspects, or in the alternative to some aspects, the flow direction fibers and the cross flow direction fibers have between 7 and 50 fibers per inch of the one or more spacing screens.

In a sixty-seventh aspect, in addition to one or more of the preceding or following aspects, or in the alternative to some aspects, the flow direction fibers and the cross flow direction fibers have between 8 and 12 fibers per inch of the one or more spacing screens.

In a sixty-eighth aspect, a method of preparing a spiral wound filtration device is included, the method includes unwinding a membrane layer and a spacing layer, combining the unwound membrane layer and the unwound spacing layer, dispensing an adhesive on a portion of the combined membrane layer and the spacing layer, and winding up the combined membrane layer and the spacing layer, wherein the spacing layer includes a plurality of spacing elements, the spacing elements include a variety of shapes at least one of the group consisting of: air foils, triangles, rhombuses, parallelograms, trapezoids, kites, trapeziums, pentagons, heptagons, octagons, and hexagon.

In a sixty-ninth aspect, in addition to one or more of the preceding or following aspects, or in the alternative to some aspects, the membrane layer and the spacing layer are unwound using a cantilever.

In a seventieth aspect, in addition to one or more of the preceding or following aspects, or in the alternative to some aspects, the method further includes a device used to unwind the membrane layer and the spacing layer alerting a user that the membrane layer can be running low and needs to be replaced.

In a seventy-first aspect, in addition to one or more of the preceding or following aspects, or in the alternative to some aspects, the spacing layer includes a supporting layer.

In a seventy-second aspect, in addition to one or more of the preceding or following aspects, or in the alternative to some aspects, wherein combining the unwound membrane layer and the unwound spacing layer includes overlapping the unwound membrane layer and the unwound spacing layer to align one or more edges of each.

In a seventy-third aspect, in addition to one or more of the preceding or following aspects, or in the alternative to some aspects, further wherein the membrane layer includes one or more spacing elements on one or more sides of the membrane layer.

In a seventy-fourth aspect, in addition to one or more of the preceding or following aspects, or in the alternative to some aspects, the portion of the combine membrane layer and the spacing layer that includes the adhesive is a width and a length of the overlapped membrane layer and the spacing layer.

In a seventy-fifth aspect, in addition to one or more of the preceding or following aspects, or in the alternative to some aspects, the adhesive is applied approximately one inch from one or more edges of the overlapped membrane layer and the spacing layer.

In a seventy-sixth aspect, in addition to one or more of the preceding or following aspects, or in the alternative to some aspects, the method can further include winding an outer wrap around the combined membrane layer and the spacing layer.

In a seventy-seventh aspect, in addition to one or more of the preceding or following aspects, or in the alternative to some aspects, the outer wrap includes an adhesive soaked membrane layer.

In a seventy-eighth aspect, in addition to one or more of the preceding or following aspects, or in the alternative to some aspects, the outer wrap is impermeable.

In a seventy-ninth aspect, a filtration device includes having a first spiral wound filter element. The first spiral wound filter element includes one or more filtration subassemblies having one or more membrane subassemblies. The one or more membrane subassemblies includes two or more supporting layers, one or membrane layers disposed in between the two or more supporting layers, and a plurality of spacing elements, and one or more spacing layers.

In an eightieth aspect, in addition to one or more of the preceding or following aspects, or in the alternative to some aspects, the filtration device further includes a second, third, and fourth spiral wound filter element, wherein the second, third, and fourth spiral wound filter elements each include one or more filtration subassemblies and one or more membrane subassemblies. The one or more membrane subassemblies include two or more supporting layers, one or membrane layers disposed in between the two or more supporting layers, and a plurality of spacing elements, and one or more spacing layers.

In an eighty-first aspect, in addition to one or more of the preceding or following aspects, or in the alternative to some aspects, the filtration device further includes a fifth, sixth, seventh, and eighth spiral wound filter element, wherein the fifth, sixth, seventh, and eighth spiral wound filter elements each include one or more filtration subassemblies and one or more membrane subassemblies. The one or more membrane subassemblies include two or more supporting layers, one or membrane layers disposed in between the two or more supporting layers, and a plurality of spacing elements, and one or more spacing layers.

In an eighty-second aspect, in addition to one or more of the preceding or following aspects, or in the alternative to some aspects, the filtration device further includes a first stack. The first stack includes the first, second, third and fourth spiral wound filter elements placed in parallel.

In an eighty-third aspect, in addition to one or more of the preceding or following aspects, or in the alternative to some aspects, the filtration device further includes a first stack and a second stack. The first stack includes the first, second, third and fourth spiral wound filter elements placed in parallel. The second stack includes the fifth, sixth, seventh, and eighth spiral wound filter elements placed in parallel.

In an eighty-fourth aspect, in addition to one or more of the preceding or following aspects, or in the alternative to some aspects, the first stack and the second stack are placed in series.

In an eighty-fifth aspect, in addition to one or more of the preceding or following aspects, or in the alternative to some aspects, the plurality of spacing elements is disposed on one or more sides of the one or more spacing layers.

In an eighty-sixth aspect, in addition to one or more of the preceding or following aspects, or in the alternative to some aspects, the plurality of spacing elements is disposed on one or more sides of the one or more membrane layers.

In an eighty-seventh aspect, in addition to one or more of the preceding or following aspects, or in the alternative to some aspects, the plurality of spacing elements includes a variety of shapes includes one or more of the following: air foils, triangles, rhombuses, parallelograms, trapezoids, kites, trapeziums, pentagons, heptagons, octagons, hexagon, circles, ovals, squares, rectangles, and teardrops.

In an eighty-eighth aspect, in addition to one or more of the preceding or following aspects, or in the alternative to some aspects, the plurality of spacing elements includes an airfoil shape.

In an eighty-ninth aspect, in addition to one or more of the preceding or following aspects, or in the alternative to some aspects, the plurality of spacing elements is arranged in a size gradient.

In a ninetieth aspect, in addition to one or more of the preceding or following aspects, or in the alternative to some aspects, the plurality of spacing elements is symmetrically distributed.

In a ninety-first aspect, in addition to one or more of the preceding or following aspects, or in the alternative to some aspects, the plurality of spacing elements is unsymmetrically distributed.

In a ninety-second aspect, in addition to one or more of the preceding or following aspects, or in the alternative to some aspects, the filtration device has an aspect ratio of less than 3:1 height to width.

In a ninety-third aspect, in addition to one or more of the preceding or following aspects, or in the alternative to some aspects, the filtration device has an aspect ratio of less than 10.5:1 height to width.

In a ninety-fourth aspect, in addition to one or more of the preceding or following aspects, or in the alternative to some aspects, the filtration device has an aspect ratio of less than 12:1.5 height to width.

In a ninety-fifth aspect, in addition to one or more of the preceding or following aspects, or in the alternative to some aspects, the filtration device has an aspect ratio of less than 8:1 height to width.

In a ninety-sixth aspect, in addition to one or more of the preceding or following aspects, or in the alternative to some aspects, the two or more spacing layers include two or more spacing screens having flow direction fibers and cross flow direction fibers, wherein the flow direction fibers are approximately oriented in the flow direction of a fluid entering the spiral wound filter element.

This summary is an overview of some of the teachings of the present application and is not intended to be an exclusive or exhaustive treatment of the present subject matter. Further details are found in the detailed description. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1A is a top view of a filtration device in accordance with various embodiments herein.

FIG. 1B is a side perspective view of a filter device in accordance with various embodiments herein.

FIG. 2 is a schematic view of a filter element in accordance with various embodiments herein.

FIG. 3A is a schematic view of two filtration subassemblies in accordance with various embodiments herein.

FIG. 3B is a cross-sectional view of four filtration subassemblies in accordance with various embodiments herein.

FIG. 4A is a cross sectional view of a filter element in accordance with various embodiments herein.

FIG. 4B is cross sectional views of filter elements in accordance with various embodiments herein.

FIG. 5 is a schematic view of a filter element in accordance with various embodiments herein.

FIG. 6A is a schematic view of filter elements in parallel in accordance with various embodiments herein.

FIG. 6B is a schematic view of filter elements in series in accordance with various embodiments herein.

FIG. 7A is a cross sectional view of filter element stacks in accordance with various embodiments herein.

FIG. 7B is a cross sectional view of filter element stacks in accordance with various embodiments herein.

FIG. 8 is a schematic view of a spacing screen in accordance with various embodiments herein.

FIG. 9 is a side view of a spacing screen in accordance with various embodiments herein.

FIG. 10A is a top-down view of a spacing elements layer in accordance with various embodiments herein.

FIG. 10B is a side view of a spacing elements layer in accordance with various embodiments herein.

FIG. 10C is a side view of a spacing elements layer in accordance with various embodiments herein.

FIG. 11A is a top-down view of a spacing elements layer in accordance with various embodiments herein.

FIG. 11B is a side view of a spacing elements layer in accordance with various embodiments herein.

FIG. 12 is a top-down view of a spacing elements layer in accordance with various embodiments herein.

FIG. 13 is a top-down view of a spacing elements layer in accordance with various embodiments herein.

FIG. 14 is a top-down view of a spacing elements layer in accordance with various embodiments herein.

FIG. 15A is a top-down view of a spacing elements layer in accordance with various embodiments herein.

FIG. 15B is a schematic view of a spacing elements layer in accordance with various embodiments herein.

FIG. 16A is a top-down view of a spacing elements layer in accordance with various embodiments herein.

FIG. 16B is a side view of a spacing elements layer in accordance with various embodiments herein.

FIG. 17 is a top-down view of a spacing elements layer in accordance with various embodiments herein.

FIG. 18 is a top-down view of a spacing elements layer in accordance with various embodiments herein.

FIG. 19 is a top-down view of a spacing elements layer in accordance with various embodiments herein.

FIG. 20 is a flow chart showing a method of preparing a spiral wound filtration device, according to an embodiment.

FIG. 21 is a graph showing the effect of spacing layer thickness on membrane surface area, according to an embodiment.

FIG. 22 is a graph showing the effect of spacing layer thickness on membrane surface area, according to an embodiment.

FIG. 23 is a graph showing the effects of the number of spacing layers on pressure drop, according to an embodiment.

FIG. 24 is a graph showing the effects of the dimensions of spacing layers on pressure drop, according to an embodiment.

FIG. 25 is a graph showing the effects of membrane layer length on pressure drop, according to an embodiment.

FIG. 26 is a graph showing the effects of membrane length on flux, according to an embodiment.

FIG. 27 is a graph showing the effects of the element diameter on several properties, according to an embodiment.

FIG. 28 is a graph showing the effects of the element length on several properties, according to an embodiment.

FIG. 29 is a graph showing the effects of the core diameter on several properties, according to an embodiment.

FIG. 30 is a graph showing the effects of the spacing screen thickness on several properties, according to an embodiment.

While embodiments are susceptible to various modifications and alternative forms, specifics thereof have been shown by way of example and drawings and will be described in detail. It should be understood, however, that the scope herein is not limited to the aspects described. On the contrary, the intention is to cover modifications, equivalents, and alternatives falling within the spirit and scope herein.

### DETAILED DESCRIPTION

### Filtration Device

The present invention is directed to filtration devices having spiral wound filtration elements, as well as methods for producing spiral wound filtration elements. The spiral wound filtration element can include one or more membrane layers disposed between one or more spacing layers. The spacing layers provide advantageous flow paths throughout the filtration element which serves to not only provide sufficient contaminant removal, but also limit the amount of pressure drop experienced throughout the filtration element during use.

The spiral wound filtration element can have an aspect ratio less than 8:1 height to width. It has been found that decreasing the height of the filtration element while increasing the width provides sufficient usable media to provide sufficient contaminant removal while decreasing the amount of pressure drop experienced. Decreasing the height while increasing the width of the filtration element can be especially desirable when the rate of fluid through the filtration element is high. However, it has further been found that decreasing the rate of fluid through the filtration element can limit the amount of pressure drop experienced thereby allowing for greater heights of the filtration element if desired.

The spiral wound filtration element can include a plurality of spacing elements disposed on one or more of the membrane layers and/or spacing layers. The use of spacing elements can provide significant benefits regarding filtration performance. For example, the spacing elements can provide structural support for the membrane layers in the filtration media and prevent the membrane layers from collapsing into the flow channel of the filtration device. Further, the spacing elements can decrease the amount of pressure drop experienced and allow contaminants to load into the depths of the channels created by the spacing elements. The spacing elements can include a variety of shapes and sizes and be disposed on the membrane layers and/or spacing layers in a variety of patterns described in more detail below.

The spiral wound filtration element can further include one or more spacing screens. Spacing screens can provide a number of benefits to the filtration device. Specifically, the spacing screens can provide additional support to the membrane layers and prevent the membrane layers from collapsing into the flow channel. Additionally, the spacing screens can include flow direction fibers that are oriented in the direction of the flow of fluid in stark contrast to traditional spacing screens that include fibers oriented at a 45-degree angle to the flow of fluid. Importantly, it has been found that orienting the flow direction fibers in the direction of the flow of fluid decreases the amount of turbulence caused by the flow of fluid thereby decreasing the amount of pressure drop experienced.

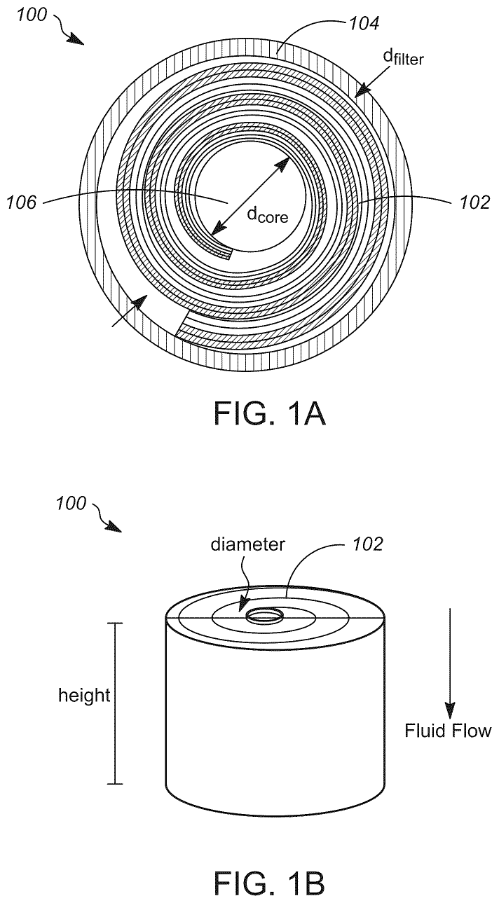

Referring now to FIG. 1A, a top view of a filtration device is shown in accordance with various embodiments herein. The filtration device 100 can include a filter element 102 wound around a core 106. The filtration device can also include an impermeable outer wrap 104. Once the desired amount of filter element media is wound around the core 106, then the filter element 102 can be wrapped with the impermeable outer wrap 104 that will maintain compression and provide structural support.

In some embodiments, the core 106 can provide structural support to the filter element 102 and prevent the filter element 102 from compressing and collapsing inward during use. In some embodiments, the core 106 can be a solid form. In other embodiments, the core 106 can be a hollow form. For example, the core 106 can be a rod or a tube. A hollow core 106 can be advantageous for applications of a plurality of filter elements stacked in parallel. When filter elements are stacked in parallel a hollow core 106 can allow for clean liquid flow from one filter element to bypass the next filter element in parallel. Both hollow and solid cores could be used by single elements, elements in series, or elements in parallel that are not in the same housing. For example, both solid and hollow cores can be used by single elements that are not in the same housing and are attached to a manifold.

The core 106 can be made from various materials. For example, the core 106 can be made from polymer, metal, composite, and the like. In some embodiments, the core 106 can be made from polypropylene. The core 106 can have a height of two inches, three inches, four inches, five inches, six inches, seven inches, eight inches, or nine inches, or can fall within a range between any of the foregoing. In some embodiments, the core 106 can have a height of between three and four inches. In other embodiments, the core 106 can have a height of between four and five inches. The core 106 can have a diameter of less than one inch. For example, the core 106 can have a diameter of ¼ inch, ½ inch, or ¾ inch, or can fall within a range between any of the foregoing. Alternatively, the core 106 can have a diameter of one inch, two inches, three inches, or four inches, or can fall within a range between any of the foregoing. In some embodiments, the core 106 can have a diameter of between ½ inch and two inches. It will be appreciated that increasing the height of the core 106, and thus the filter element 102, can increase the amount of pressure drop experienced. As such, it can be desirable to increase the diameter of the filter element 102 to avoid this result.

In some embodiments, the filter element 102 can include one or more spacing layers in between one or more membrane layers. The membrane layers can be made from various materials. For example, the membrane layers can be made from polymer, glass, composite, and the like.

In some embodiments, the membrane layers can include material sufficient to create fibrous membrane layers. For example, the membrane layers can include cellulose, cellulose with thermoplastic resins, cellulose with thermoset resins, and the like. In some embodiments, the membrane layers can include thermoplastic polymers such as polypropylene. In some embodiments, the membrane layers can include materials that can be formed into a spiral wound design but are traditionally difficult to use in pleated designs. For example, the membrane layers can include thermoset resins, thermoplastic resins, and thermoplastic polymers such as polyethersulfone (PES), polytetrafluoroethylene (PTFE), cellulose acetate, polyvinylidene fluoride (PVDF), polysulphone (PS), nylon, and polypropylene, polyethylene, polyester, and the like. For example, the membrane layers can include meltblown membranes and wet laid membranes such as Donaldson Company Inc.'s Synteq™ XP media.

The membrane layers and spacing layers can each have an unwound length of 50 feet, 100 feet, 150 feet, 200 feet, 250 feet, 300 feet, 350 feet, 400 feet, or 450 feet, or can fall within a range between any of the foregoing. For example, the layers can have an unwound length of approximately 200 feet. The layers can have various widths. In some embodiments, the layers can have a width of two inches, three inches, four inches, five inches, six inches, seven inches, or eight inches, or can fall within a range between any of the foregoing. For example, the layers can have a width of four inches. Additionally, the layers can have varying thicknesses. In some embodiments, the layers can have a thickness of 50 microns, 100 microns, 150 microns, 200 microns, 250 microns, 300 microns, 350 microns, 400 microns, 450 microns, 500 microns, 550 microns, 600 microns, 650 microns, 700 microns, 750 microns, 800 microns, 850 microns, 900 microns, 950 microns, or 1000 microns, or can fall within a range between any of the foregoing. It is noted that the thicker the layers are, the shorter the length the unwound layers can be in order to be rolled into the filtration device at a fixed diameter.

In some embodiments, the spacing layers serve to provide structural support to the filter element 102. In various embodiments, the spacing layers can include supporting layers including spacing screens and/or scrims described in more detail below. In various embodiments, alternatively or in addition, the spacing layers can include spacing elements attached to one or both side of the membrane layers, described in more detail below.

The filter element 102 can be spirally wound around the core 106. A basic spiral wound filter is shown in U.S. Pat. No. 3,962,097 the contents of which is incorporated by reference in its entirety. Embodiments described herein can be constructed according to the teaching of U.S. Pat. No. 3,962,097.

Referring now to FIG. 1B, a side perspective view of a filter device is shown in accordance with various embodiments herein. FIG. 1B shows the generally axial direction of fluid flow through the filter element 102. The filter element 102 has a height and a diameter.

The filtration device 100 can have various dimensions. The filtration device 100 can have a height of two inches, three inches, four inches, five inches, six inches, seven inches, eight inches, nine inches, or ten inches, or can fall within a range between any of the foregoing. In some embodiments, the height of the filtration device 100 can have a height between three inches and four inches. In some embodiments, the height of the filtration device 100 can have a height between four inches and five inches. The filtration device 100 can have a diameter of 2 inches, 5 inches, 10 inches, 15 inches, 20 inches, 25 inches, 30 inches, 35 inches, or 40 inches, or can fall within a range between any of the foregoing. In some embodiments, the filtration device 100 can have a diameter of between 16 inches and 24 inches. For example, the filtration device 100 can have a diameter between 10 and 24 inches. More specifically, the filtration device 100 can have a diameter of 16 inches. It will be appreciated that increasing the height of the filtration device 100 can increase the amount of pressure drop experienced. In some embodiments, the height of the filtration device 100 can be less than 6 inches to minimize the amount of pressure drop experienced. It is noted that the shorter the height of the filtration device 100, the greater the flow rate of fluid can be through the filtration device 100 without affecting the amount of pressure drop experienced. In other embodiments, the rate of fluid flow through the filtration device 100 can be decreased to minimize the effects of the pressure drop experienced if the height of the filtration device 100 is greater than 6 inches.

The filtration device 100 has an aspect ratio, which is the ratio of height to width. In some embodiments, the filtration device can have an aspect ratio similar to a hockey puck (1:3), frisbee (1:10.5), or pizza box (1.5:12), or can fall within a range, above or between any of the foregoing. For example, the aspect ratio can be 1:6, 1:5, 1:4, 1:2, 1:1, 6:3, or 4:16. In some embodiments the filtration device can have a higher aspect ratio, such as 2:1, 3:1, 4:1, 5:1, 6:1, 7:1, 8:1, 9:1, 10:1, or can fall within a range below or between any of the foregoing.

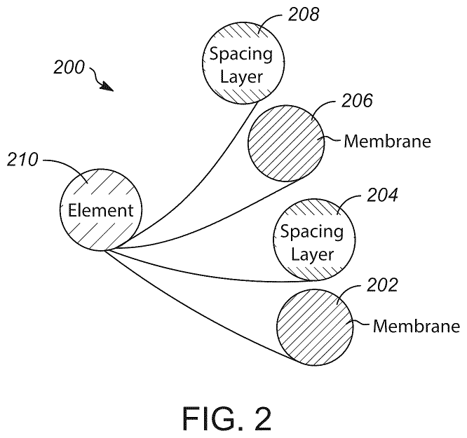

Referring now to FIG. 2, a schematic view of a filter element during the winding process is shown in accordance with various embodiments herein. As shown, filter element 200 can include a membrane layer 202 with a spacing layer 204 disposed on top, followed by a membrane layer 206 and a spacing layer 208. It will be appreciated that while FIG. 2 depicts two layers of membrane and two layers of spacing layers, more layers are contemplated herein. For example, the filter element 200 can include three layers, four layers, five layers, six layers, seven layers, eight layers, or more each of the membrane layers and/or spacing layers. In some embodiments, the membrane layer 202 and the membrane layer 206 can be made from the same material. In other embodiments, the membrane layer 202 and the membrane layer 206 can be made from different materials. Similarly, in some embodiments, the spacing layer 204 and the spacing layer 208 can be made from the same material. In other embodiments, the spacing layer 204 and the spacing layer 208 can be made from different materials. In some embodiments, the membrane layers 202, 206 and the spacing layers 204, 208 can all be made from the same material, which can be beneficial for the manufacturing of the filter element 200 because the adhesive used can wet similarly with all of the layers. In other embodiments, one or more of the membrane layers 202, 206 and the spacing layers 204, 208 can be made from a different material to the other layers which can add separate functionality such as increased wettability in the process fluid, anti-fouling, or limiting bacterial growth.

In some embodiments, the membrane layer 202, the spacing layer 204, the membrane layer 206, and the spacing layer 208 can be wound around a core 210 in a spiral. Spirally winding the layers of the filter element 200 can increase the surface area of the membrane layer by double or more compared to traditionally pleated filter elements having the same outer diameter of the filter element 200. It will be noted that the surface area of the membrane layer that can be incorporated into a filter element of a given outer diameter is determined by the thickness of the membrane layer, the thickness of the flow channel defining the spacing layer's height, and the diameter of the core. Increasing the membrane surface area can have many benefits. Some benefits include lower pressure drop penalties, longer filter life, higher flux, use of more efficient membrane, and reduction of filtration device size.

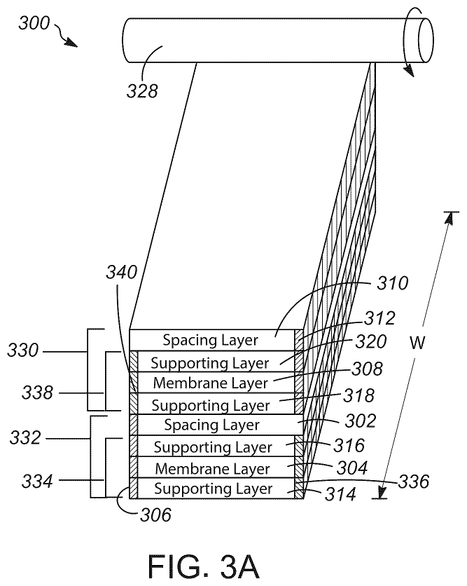

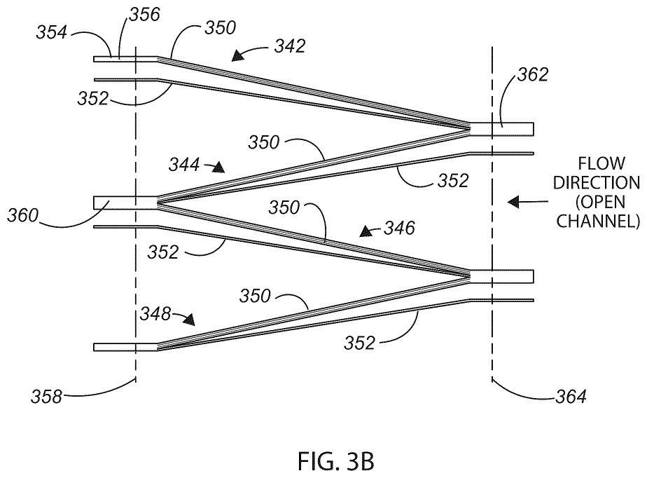

Referring now to FIG. 3A, a schematic view of two filtration subassemblies is shown in accordance with various embodiments herein. While the example of FIG. 2 included a spacing layer in between each membrane layer, the example of FIG. 3 shows a spacing layer separating membrane subassemblies, where each membrane subassembly includes a membrane supported by and sandwiched between two supporting layers. In another embodiment, each membrane is supported by one supporting layer. Options for a supporting layer include a scrim layer and a screen layer. The combination of a membrane subassembly and a spacing layer is referred to herein as a filtration subassembly.

To form the spiral wound filter element 300, a second filtration subassembly 330 can be disposed on top of a first filtration subassembly 332. The first filtration subassembly 332 can include a first membrane subassembly 334 and a first spacing layer 302. The first membrane subassembly 334 can include a first membrane layer 304 disposed on top of a first supporting layer 314 and a second supporting layer 316 disposed on top of the first membrane layer 304. The first spacing layer 302 can be disposed on top of the first membrane subassembly 334. A first adhesive 336 can be applied along a length of the first supporting layer 314, the first membrane layer 304, and the second supporting layer 316. The adhesive 336 can serve to attach the first membrane layer 304 to the first supporting layer 314 and the first membrane layer 304 to the second supporting layer 316 to form the first membrane subassembly 334. A second adhesive 306 can be applied along a length opposite the first adhesive 336 of the first membrane subassembly 334 and the first spacing layer 302. The second adhesive 306 can serve to attach the layers of the first membrane subassembly to each other and to attach the first membrane subassembly 334 to the first spacing layer 302 to form the first filtration subassembly 332. The adhesives 306, 336 can also serve to provide impermeable seams. It will be appreciated that ensuring the integrity of the seams is valuable. Preventing leaks in the seams can increase the performance of the filtration device and ensure its proper function. The seams can have various widths. In some embodiments, the seams can have a width of ⅛ inch, ¼ inch, ½ inch, ¾ inch, or 1 inch, or can fall within a range of any of the foregoing. For example, the seams can have a width of ½ inch. It will be appreciated that it is desirable to minimize the size of the seams to increase the surface area of usable spiral wound filter element 300.

The second filtration subassembly 330 can include a second membrane subassembly 338 and a second spacing layer 310. The second membrane subassembly 338 can include a third supporting layer 318, a second membrane layer 308, and a fourth supporting layer 320. The second membrane layer 308 can be disposed on top of the third supporting layer 318 and the fourth supporting layer 320 can be disposed on top of the second membrane layer 308. The second spacing layer 310 can be disposed on top of the second membrane subassembly 338. A third adhesive 340 can be applied along a length of the third supporting layer 318, the second membrane layer 308, and the fourth supporting layer 320. The third adhesive 340 can serve to attach the third supporting layer 318 to the second membrane layer 308 and the fourth supporting layer 320 to the second membrane layer 308 to form the second filtration subassembly 330. A fourth adhesive 312 can be applied along a length opposite the third adhesive 340 of the second membrane subassembly 338 and the second spacing layer 310. The fourth adhesive 312 can serve to attach the second membrane subassembly 338 to the second spacing layer 310 to form the second filtration subassembly 330, and also serves to attach the components of the second membrane subassembly 338 to each other. The adhesives 312, 340 can also serve to provide impermeable seams as discussed above with respect to the first filtration subassembly 332. The first filtration subassembly 332 and the second filtration subassembly 330 can then be wound lengthwise around core 328 to form the filter element. It will be appreciated that the second membrane subassembly 338 can consist of the first membrane subassembly 334 folded back on itself with the first spacing layer 302 tucked in between the fold of the first membrane subassembly 334. As used herein, membrane layers can also be called media layers and can use a variety of types of media. Additionally, supporting layers can be scrim layers or spacing screens and can use a variety of types of media.

Each spacing layer 302, 310 is adhered to a neighboring membrane assembly layer at one lateral edge in the machine direction, while the other lateral edge in the machine direction of the spacing layer is not adhered to a neighboring membrane assembly in order to allow entry into or exit from a flow channel. The next spacing layer in the filtration element is adhered to a neighboring membrane assembly at the lateral edge on the opposite side of the filtration element as the previous spacing layer. For example, the first spacing layer 302 is adhered to the neighboring first membrane subassembly 334 at the second adhesive 306 on the left side of the filtration element 300, while second spacing layer 310 is adhered to second membrane subassembly 338 by fourth adhesive 312 at the right side of the filtration element 300. In some embodiments, the adhesives 306, 312, 336, and 340 can include an epoxy or polyurethane such as commercially available adhesive UR3543, available from H.B. Fuller Company, which has a business location in St. Paul, Minnesota, USA or adhesive Conap® AD-6411, available from ELANTAS Group, which has a business location in Hamburg, Germany. In some embodiments, the adhesives 306, 312, 336, and 340 can include any adhesive capable of wetting the spacing layers and the membrane layers both without flowing through either layer. Additionally, the adhesives 306, 312, 336, and 340 can include any adhesive capable of filling the voids in the materials of the spacing layers and membrane layers to prevent any leak paths or bypass of the filters. It is noted herein that the proper adhesive to be utilized is dependent on the specific materials of the spacing layers and membrane layers.

Referring now to FIG. 3B, a cross-sectional view of four filtration subassemblies is shown in accordance with various embodiments herein. A first filtration subassembly 342, a second filtration subassembly 344, a third filtration subassembly 346, and a fourth filtration subassembly 348 are layered together and wound around a core to form a filtration element. The machine direction of the layers goes into the plane of the FIG. 3B. Each of the first filtration subassembly 342, the second filtration subassembly 344, the third filtration subassembly 346, and the fourth filtration subassembly 348 can include a membrane subassembly 350 and a spacing layer 352.

In some embodiments, the membrane subassembly 350 can include a first supporting layer, such as a first scrim layer, a membrane layer, and a second supporting layer, such as a second scrim layer. In other embodiments, the membrane subassembly 350 can include a membrane layer. In other embodiments, the membrane subassembly 350 can include a membrane layer and a single supporting layer, such as a first scrim. The components of the membrane subassembly 350 can be attached to each other using a first adhesive 354. As shown, the first adhesive 354 can be applied in the machine direction along the length of the edge of first supporting layer, membrane layer, and second supporting layer. The first adhesive 354 can serve to attach the membrane layer to the first supporting layer and the second supporting layer to form the membrane subassembly 350. The first adhesive 354 can create a seam 356. During the manufacturing process the seam 356 created is larger than the seam in the end product. By creating a larger seam 356 during the manufacturing process, it ensures there is adequate adhesion between the first supporting layer, membrane layer, and second supporting layer. Once sufficiently adhered, the seam 356 can be trimmed along cut line 358 to remove the excess unusable media layers.

In some embodiments, a second adhesive 360 can be applied along a length of the membrane subassembly 350 and the spacing layer 352 at the edge opposite to the location of first adhesive 354. The second adhesive 360 can serve to attach the membrane subassembly 350 to the spacing layer 352, as well as to attach the components of the membrane subassembly to each other. The second adhesive 360 can create a seam 362. During the manufacturing process the seam 362 created is larger than the seam in the end product. By creating a larger seam 362 during the manufacturing process, it ensures there is adequate adhesion between the membrane subassembly 350 and the spacing layer 352. Once sufficiently adhered, the seam 362 can be trimmed along cut line 364 to remove the excess unusable media layers.

The first adhesive 354 and a second adhesive 360 have been described regarding how they adhere the layers of the first filtration subassembly 342. The pattern repeats in the second, third, and fourth filtration subassemblies 344, 346, and 348. As discussed with respect to FIG. 3A, it can be seen in FIG. 3B that each spacing layer 352 is adhered to a neighboring membrane assembly 350 at one lateral edge in the machine direction, while the other lateral edge in the machine direction of the spacing layer is not adhered to that a membrane subassembly in order to allow entry into or exit from a flow channel.

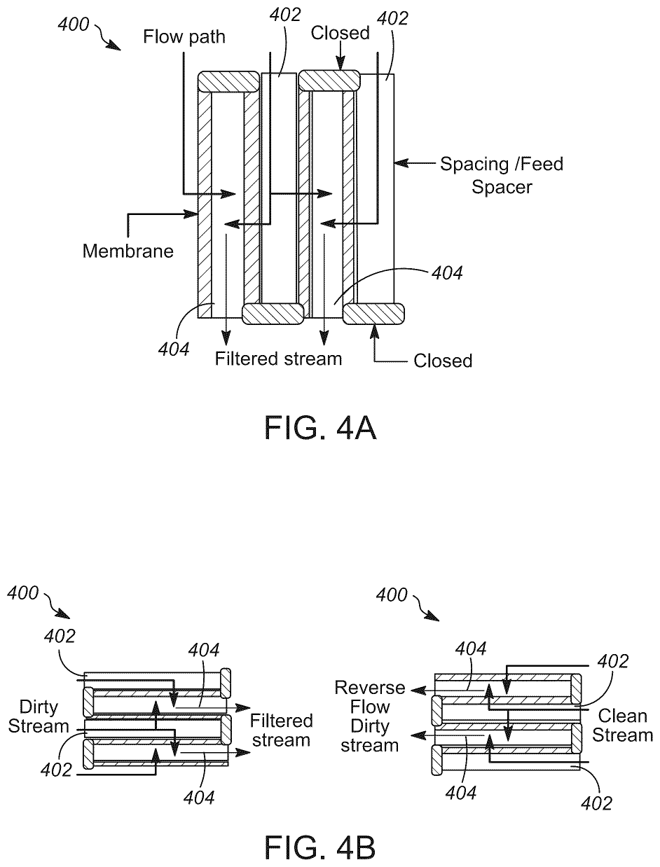

In some embodiments, forming the spiral filter element creates a filter element having axial flow. Referring now to FIG. 4A, a cross sectional view of a filter element is shown in accordance with various embodiments herein. As shown, fluid can enter the filter element 400 through membrane layers 402 that have not been closed by the creation of a seam. Fluid can then axially flow through the filter element 400 and exit through adjacent membrane layers 404 that have not been closed by the creation of a seam.

In some embodiments, if the spacing layers are the same and the membrane layers are isotropic, equal forces can be applied when fluid flows through the filter element 400 and when fluid is backflushed through the filter element 400. Referring now to FIG. 4B, cross sectional views of filter elements are shown in accordance with various embodiments herein. As shown, fluid can enter the filter element 400 through membrane layers 402 that have not been closed by the creation of a seam. Fluid can then axially flow through the filter element 400 and exit through adjacent membrane layers 404 that have not been closed by the creation of a seam. It will be appreciated, that regardless of the fluid flowing in the forward or reverse direction through the filter element 400, the flow path length is the same.

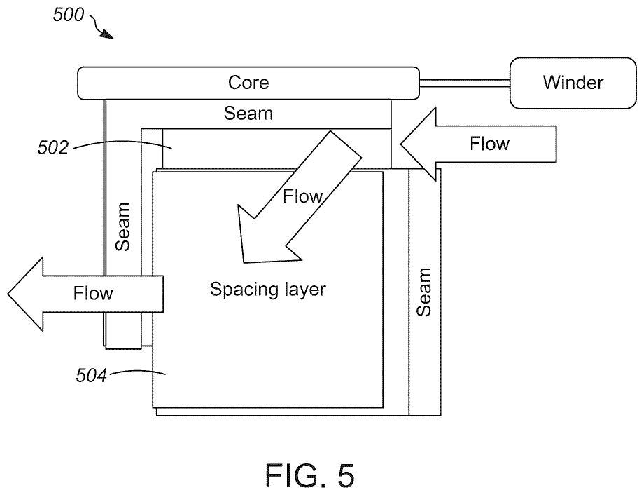

Referring now to FIG. 5, a schematic view of a filter element is shown in accordance with various embodiments herein. FIG. 5 provides another illustration of the path of fluid flow through filter element 500. Specifically, fluid can enter through membrane layer 502 and exit through adjacent membrane layer 504. Axial flow patterns can provide forward and reverse fluid flows that create the same flow path lengths thereby enhancing the performance of the filtration device.

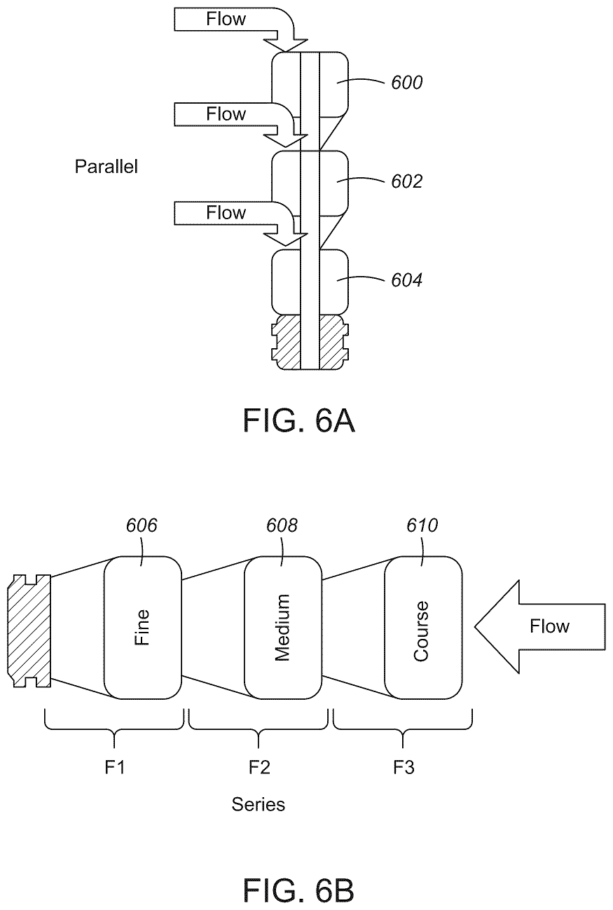

By creating a filter element having axial flow, opportunities for a plurality of filter elements to be placed in parallel are possible, as seen in FIG. 6A, a schematic view of filter elements 600, 602, 604 in parallel is shown in accordance with various embodiments herein. Additionally, opportunities are created for a plurality of filter elements to be placed in series as seen in FIG. 6B, a schematic view of filter elements 606, 608, 610 in series is shown in accordance with various embodiments herein. It will be appreciated that placing a plurality of filter elements in parallel or series can allow for the filter elements to be connected directly to existing piping without the need for larger multi filter housings. The ability to do both series and parallel options enables simple customization options for different applications. Different membrane layers and spacing layers can be used in any specific filter both in series and parallel as is beneficial for the application.

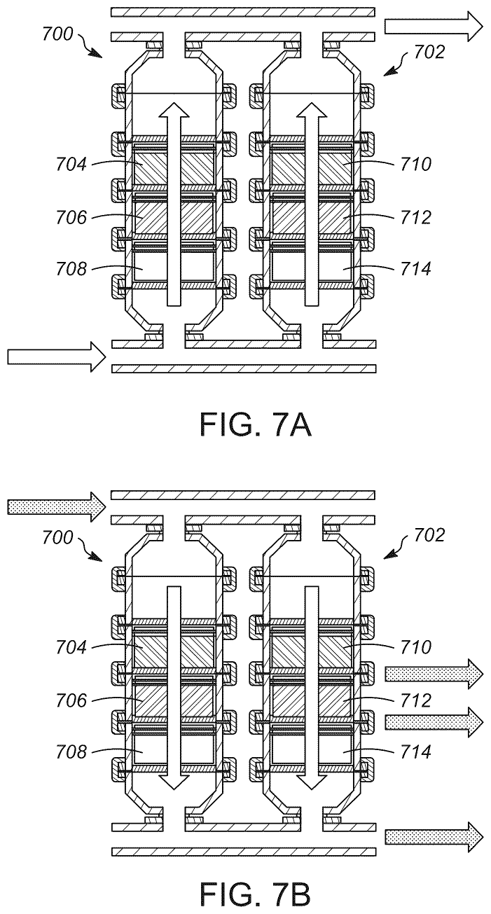

The axial flow allows additional opportunities for individual filter elements to be placed in parallel and for the stacks of filter elements created to be placed in series, as seen in FIGS. 7A and 7B. Referring now to FIG. 7A, a cross sectional view of filter element stacks 700, 702 is shown in accordance with various embodiments herein. As shown, individual filter elements 704, 706, 708 are placed in parallel and make up filter element stack 700. Similarly, individual filter elements 710, 712, 714 are placed in parallel and make up filter element stack 702. In some embodiments, more than three filter elements can make up a filter element stack. For example, in various embodiments, four filter elements, five filter elements, six filter elements, seven filter elements, eight filter elements, or nine filter elements can make up a filter element stack. In one embodiment, the filter elements are increasingly restrictive along the fluid flow path. For example, filter elements 708 and 714 can be course filter elements, filter elements 706 and 712 can be medium filter elements, and filter elements 704 and 710 can be fine filter elements.

Two filter element stacks 700 and 702 can be placed in series. This creates axial fluid flow through the filter element stacks 700, 702 as indicated by the arrows. FIG. 7B, a cross sectional view of filter element stacks 700, 702 is shown in accordance with various embodiments herein. FIG. 7B illustrates how backflush fluid can flow through the filter element stacks 700, 702 as indicated by the arrows. In some embodiments, more than two filter element stacks can be placed in series. For example, in various embodiments, three filter element stacks, four filter element stacks, five filter element stacks, six filter element stacks, seven filter element stacks, eight filter element stacks, or nine filter element stacks can be placed in series.

### Spacing Screen

The filtration device described herein can include one or more supporting layers including spacing screens. In various embodiments, the filtration device can include a plurality of spacing screen layers. For example, the filtration device can include one layer, two layers, three layers, four layers, five layers, or six layers of spacing screens. In some embodiments, the filtration device can include two layers of spacing screens. If the filtration device includes more than one layer of spacing screen, the spacing screens can be separated by layers of membrane and/or spacing elements, described in more detail below.

The spacing screens can be made from various materials. In various embodiments, the spacing screens can be made from woven, non-woven, partially woven, or other materials that can define a fluid flow path. For example, the spacing screen can be made from polymer, metal, composite, and the like. In some embodiments, the spacing screen can include thermoplastic polymers such as polypropylene, high-density polyethylene (HDPE), polyester, nylon, and polyphenylene sulfide (PPS). In some embodiments, the spacing screen can include a coating. In various embodiments, the spacing screen can include an antifouling coating, conductive coatings for electrostatic discharge, and coatings containing sorbents to target specific contaminants.

Spacing screens can serve various purposes. For example, the spacing screens can provide support to the one or more layers of membrane. Support to the layers of membrane can assist in creating channels within the filtration device for fluid to flow thus preventing the membranes from collapsing when fluid is introduced into the filtration device. Additionally, spacing screens can be designed to minimize the channel pressure drop. experienced by the filtration device when fluid is introduced. Reducing the amount of pressure drop can be advantageous to increase the performance of the filtration device and reduce the total amount of energy consumed.

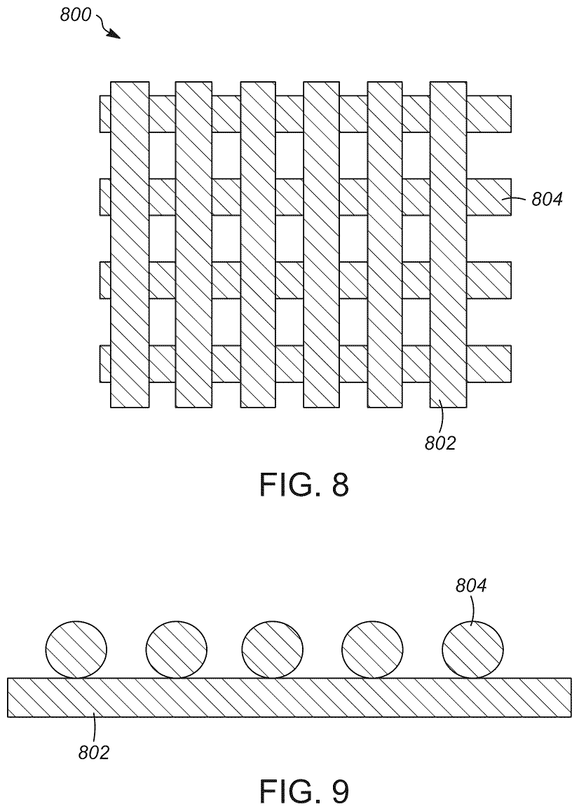

Referring now to FIG. 8, a schematic view of a spacing screen is shown in accordance with various embodiments herein. Spacing screen 800 can include cross flow direction fibers 802 and flow direction fibers 804. In this context, the flow direction refers to the direction of fluid flow through the filter element and cross flow direction refers to the direction perpendicular to the flow of fluid through the filter element. It will be appreciated that while the fibers 802 and 804 are described as cross flow and flow direction fibers respectively, the exact orientation of the cross flow direction fibers 802 and flow direction fibers 804 may not be exactly in the direction of fluid flow and cross fluid flow. When the spacing screen 800 is manufactured or is being used in manufacturing a filter element, cross machine direction approximately equates to the flow direction and the machine direction approximately equates to the cross flow direction. In this context, the machine direction refers to the direction that material unwinds as it is being fed into the screen manufacturing machine and the cross machine direction refers to the direction perpendicular to the machine direction. It is noted that orienting the spacing screen 800 to create flow direction fibers 804 and cross flow direction fibers 802 can be advantageous for the following reasons. First, there is a decrease in the amount of turbulence caused by the flow of fluid through the filtration device. This is especially true when compared to the traditional orientation of the spacing screens in filtration devices which place the spacing screens at an approximately 45-degree angle to the flow of fluid through the device. Second, reducing the turbulence can decrease the amount of pressure drop experienced. Lastly, an increase in the amount of contaminate loaded into the filtration device can be experienced.

In some embodiments, the flow direction fibers 804 are oriented in the approximate direction of the flow of the fluid entering the filtration device and the cross flow direction fibers 802 are approximately oriented perpendicular to the flow of fluid entering the filtration device. It will be appreciated that the term approximately used herein can refer to any angle that is less than 45 degrees. In some embodiments, the flow direction fibers 804 can be oriented at a 0-degree angle, 5-degree angle, 10-degree angle, 15-degree angle, 20-degree angle, 25-degree angle, 30-degree angle, 35-degree angle, or 40-degree angle to the flow of fluid or can fall within a range of any of the foregoing. For example, the flow direction fibers 804 can be oriented at an angle between 5-degrees and 10-degrees to the flow of fluid. In some embodiments, the cross flow direction fibers 802 can be oriented at a 0-degree angle, 5-degree angle, 10-degree angle, 15-degree angle, 20-degree angle, 25-degree angle, 30-degree angle, 35-degree angle, or 40-degree angle perpendicular to the flow of fluid, or can fall within a range of any of the foregoing. For example, the cross flow direction fibers 802 can be oriented at an angle between 5-degrees and 10-degrees perpendicular to the flow of fluid. In contrast, many prior art systems have screen fibers oriented at approximately 45 degrees to the direction of flow. In the embodiments described herein, the fibers of the spacing screen are not positioned at 45-degree angles to the direction of flow.

In some embodiments, the cross flow direction fibers 802 are provided to hold the flow direction fibers 804 in a desired position. FIG. 9 illustrates a side view of a spacing screen in accordance with various embodiments herein.

In various embodiments, the cross flow direction fibers 802 and the flow direction fibers 804 can have a variety of shapes. By way of example, the cross flow direction fibers 802 and the flow direction fibers 804 can be circular, polygonal, oval, lima bean shaped, triangular, trilobal, lobular, mushroom shaped, dog-bone shaped, ribbon-shaped, star shaped, tubular, and the like. It will be appreciated that the shape of the flow direction fibers 804 and cross flow direction fibers 802 can affect the amount of pressure drop experienced.

In various embodiments, the flow direction fibers 804 and the cross flow direction fibers 802 can have the same fiber size. In other embodiments, the flow direction fibers 804 and cross flow direction fibers 802 can have varying sizes. In some embodiments, the flow direction fibers 804 can be larger than the cross flow direction fibers 802. It will be appreciated that larger flow direction fibers 804 are advantageous because the flow direction fibers 804 can create and hold open channels in the filtration device (not shown) for allowing fluid to flow through the filtration device. Additionally, larger flow direction fibers 804 and/or flow direction fibers 804 that are the same size as the cross flow direction fibers 802 can decrease the amount of pressure drop experienced when fluid flows through the filtration device. Similarly, smaller cross flow direction fibers 802 are advantageous as smaller fibers minimizes the surface area on the spacing screen 800 that could capture particles and reduce the performance of the filtration device Minimizing the surface area on the spacing screen 800 can also decrease the amount of viscous drag thereby minimizing the amount of pressure drop.

In some embodiments, the flow direction fibers 804 can be 25 microns, 50 microns, 100 microns, 200 microns, 250 microns, 300 microns, 350 microns, 400 microns, 450 microns, 500 microns, 600 microns, 700 microns, 800 microns, 900 microns, or 1000 microns large, or can fall within a range between any of the foregoing. In some embodiments, the flow direction fibers 804 can be between 300 microns and 700 microns large. For example, the flow direction fibers 804 can be 450 microns. In other embodiments, the flow direction fibers 804 can be between 500 microns and 1000 microns large. For example, the flow direction fibers 804 can be 750 microns large. In some embodiments, the cross flow direction fibers 802 can be 25 microns, 50 microns, 100 microns, 150 microns, 200 microns, 250 microns, 300 microns, 400 microns, 500 microns, 600 microns, 700 microns, 800 microns, 900 microns, or 1000 microns large, or can fall within a range between any of the foregoing. In some embodiments, the cross flow direction fibers 802 can be between 25 microns and 100 microns large. For example, cross flow direction fibers 802 can be 50 microns. In other embodiments, the cross flow direction fibers 802 can be between 300 microns and 600 microns large. For example, the cross flow direction fibers 802 can be 500 microns large.

In various embodiments, the spacing screen 800 can have a thickness of 100 microns, 200 microns, 300 microns, 400 microns, 500 microns, 600 microns, 700 microns, 800 microns, 900 microns, or 1000 microns, or can fall within a range between any of the foregoing. For example, the spacing screen 800 can have a thickness between 500 and 700 microns. It is noted that the thickness of the spacing screen 800 should be large enough to create sufficient channels to prevent a drop in pressure when fluid flows through the filtration device, but not too large such that the spacing screen 800 cannot be wound up.

In some embodiments, the spacing screen 800 can have between 10 and 90 percent open area. In this context, open area refers to the average percentage of cross-sectional area that is not blocked by the cross flow direction fibers 802 and flow direction fibers 804 and is thus available for the flow of fluid. Therefore, in some embodiments the flow direction fibers 804 and cross flow direction fibers 802 can have a total average fiber diameter that blocks 10 percent, 20 percent, 30 percent, 40 percent, 50 percent, 60 percent, 70 percent, 80 percent, or 90 percent, or can fall within a range between any of the foregoing of the open area of the spacing screen 800. For example, the flow direction fibers 804 and cross flow direction fibers 802 can have a total average fiber diameter that blocks 60 percent of the open area of the spacing screen 800. It is noted that the higher the percent of open area in the spacing screen 800 the greater the amount of loading of particles while at the same time the less structural support is provided to define the flow channel. In some embodiments, the flow direction fibers 804 and cross flow direction fibers 802 can have 7 fibers, 8 fibers, 9 fibers, 10 fibers, 11 fibers, 12 fibers, 13 fibers, 14 fibers, 15 fibers, or 16 fibers per inch of the spacing screen 800. For example, the flow direction fibers 804 and cross flow direction fibers 802 can have 8 to 12 fibers per inch of the spacing screen. In other embodiments, the flow direction fibers 804 and cross flow direction fibers 802 can have 15 fibers, 20 fibers, 25 fibers, 30 fibers, 35 fibers, 40 fibers, 45 fibers, or 50 fibers per inch of the spacing screen 800.

### Scrim Layers

The filtration device described herein can include one or more supporting layers including scrim layers. In various embodiments, the filtration device can include a plurality of scrim layers. For example, the filtration device can include one layer, two layers, three layers, four layers, five layers, six layers, seven layers, eight layers, nine layers, or ten layers of scrim layers. In some embodiments, each membrane layer can be sandwiched between a first and second scrim layer. In some embodiments, the filtration device can include four layers of scrim layers. If the filtration device includes more than one layer of scrim layers, the scrim layers can be separated by layers of membrane and/or spacing layers, described in more detail above.

The scrim layers can be made from various materials. In various embodiments, the scrim layers can be made from woven, non-woven, partially woven, or other materials that can define a fluid flow path. For example, the scrim layers can be made from polymer, metal, composite, and the like. In some embodiments, the scrim layers can include thermoplastic polymers such as polypropylene, high-density polyethylene (HDPE), polyester, nylon, and polyphenylene sulfide (PPS). In some embodiments, the scrim layers are made from commercially available products including Tekton 3151C or Typar® 3091L, both available from Berry Global, Inc., located in Evansville, Indiana.

The scrim layers can serve various purposes. For example, the scrim layers can provide support for the membrane layers. Supporting the membrane layers can prevent the collapse of the membrane layers into the flow channel during use of the filtration device. The scrim layers can further provide support for the membrane layers to prevent collapse of the membrane layers into the flow channel during backflushing of the filtration device. Additionally, the scrim layers allow for higher fluid pressures to be utilized during forward and backflushing.

In various embodiments, the scrim layers can have a thickness of 100 microns, 200 microns, 300 microns, 400 microns, 500 microns, 600 microns, 700 microns, 800 microns, 900 microns, or 1000 microns, or can fall within a range between any of the foregoing. For example, the scrim layers can have a thickness between 500 and 700 microns.

### Spacing Elements

The filtration device described herein can include one or more spacing layers including spacing elements layers. In some embodiments, the filtration device can include one layer, two layers, three layers, four layers, five layers, or six layers of spacing elements. By way of example, the filtration device can include two layers of spacing elements. A layer of spacing elements can be disposed on one or both sides of a filtration membrane. It will be appreciated that in filtration devices having more than one layer of spacing elements, the layers of spacing elements can be separated with layers of membrane and/or spacing screens in between each spacing element layer.

In various embodiments, the filtration device can include one or more layers of spacing elements and one or more layers of spacing screens. For example, the filtration device can include one layer of spacing elements and one layer of spacing screens. It will be appreciated that a membrane layer can separate the spacing element layer from the spacing screen layer. For example, referring back to FIG. 2, the filter element 200 can include the membrane layer 202 with the spacing layer 204 including spacing elements, followed by the membrane layer 206, and the spacing layer 208 including a spacing screen. In some embodiments, spacing elements can be disposed on membrane layers 202 and/or 206 without a separate spacing layer 204 in between. In some embodiments, the spacing elements can be disposed on membrane layers 202 and/or 206 with a separate spacing layer 204 in between. It will be appreciated that spacing elements can be disposed on a side of the membrane layers 202 and/or 206. In other embodiments, the spacing elements can be disposed on both sides of the membrane layers 202 and/or 206. In other embodiments, the spacing screens can include one or more spacing elements disposed thereon. For example, the spacing screens can include one side having one or more spacing elements disposed thereon. Alternatively, the spacing screens can include both sides having one or more spacing elements disposed thereon. In other embodiments, a spacing layer can include a hybrid of a spacing screen and spacing elements. For example, one side of the spacing layer can include a spacing screen and the other side can include spacing elements.

The spacing elements layer can include a plurality of spacing elements within the layer. In some embodiments, the spacing elements can be disposed on one side of the layer. In other embodiments, the spacing elements can be disposed on both sides of the layer. It will be appreciated that if spacing elements are disposed on both sides of the layer, the pattern on each side of the layer can be the same or different. Additionally, the shapes of the spacing elements on each side of the layer can be the same or different. These spacing elements can serve various purposes. For example, the spacing elements can create flow channels providing support to the one or more layers of membrane. It is noted that providing structural support to the layers of membrane is important to create channels within the filtration device for fluid to flow thus preventing the membranes from collapsing when fluid is introduced into the filtration device. It is further noted the flow channels must be large enough to prevent blockage during use, as such it is believed the flow channel width should be a minimum of 10 times greater than the largest sized contaminate particles being filtered. Further, flow channels can be designed to direct fluid flow to enable a uniform flow field. Additionally, spacing elements can reduce the amount of pressure drop experienced by the filtration device when fluid is introduced. Reducing the amount of pressure drop can be advantageous to increase the performance of the filtration device and reduce the total amount of energy consumed. Further, spacing elements can be used as manufacturing aids during the assembly of the filtration device by providing indicators for where to fold or apply adhesive. Further purposes include allowing particles to load in the depth of the channels created by the spacing elements, minimizing the amount of particles loaded onto the pillars in forward and reverse fluid flow, aid in seaming of the filtration device by either placing the spacing elements in an arrangement to enable proper welding/bonding or be used as the actual bonding adhesive, and allow for fouling.

In some embodiments, the spacing elements layer can have similar overall dimensions to that described above with respect to the spacing screen. For example, in some embodiments, the spacing elements can have a thickness of between 100 microns, 200 microns, 300 microns, 400 microns, 500 microns, 600 microns, 700 microns, 800 microns, 900 microns, and 1000 microns, or can fall within a range between any of the foregoing. For example, the spacing elements can have a thickness of 560 microns thick. One example of a spacing element having elements with a thickness of 560 microns is SWM part number NO2015 90PP-NAT available from SWM International, owed by Mativ, having a place of business in Alpharetta, Georgia, USA.

In other embodiments, the spacing elements can have a thickness of 890 microns thick. One example of a spacing element having elements with a thickness of 890 microns is SWM part number 410-000322 available from SWM International, owed by Mativ, having a place of business in Alpharetta, Georgia, USA.

It will be appreciated that the thickness of the spacing elements is directly related to the overall width of the flow channel created by the spacing elements. Spacing elements can be arranged in columns and rows on spacing media. For example, in various embodiments, the spacing elements can be arranged in diagonal columns. In other embodiments, the spacing elements can be arranged in straight columns. In some embodiments, the spacing element can be arranged in offset rows. In some embodiments, the spacing elements can create a micropatterned exterior surface of the spacing media. In some embodiments, the spacing elements can be spaced apart by one millimeter, two millimeters, three millimeters, four millimeters, or five millimeters, or can fall within a range between any of the foregoing.

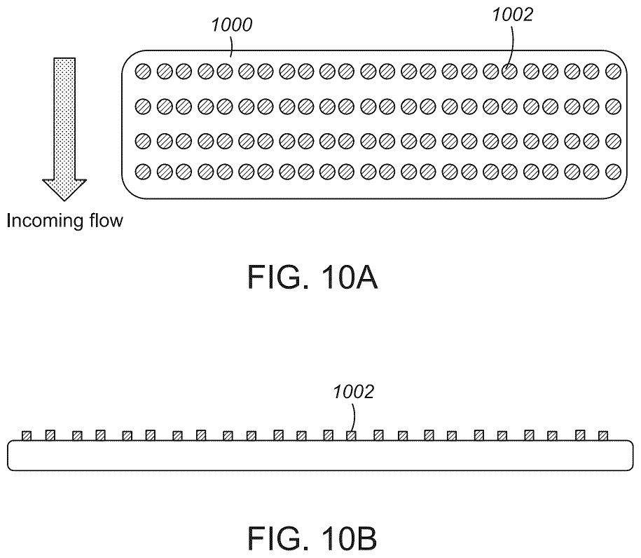

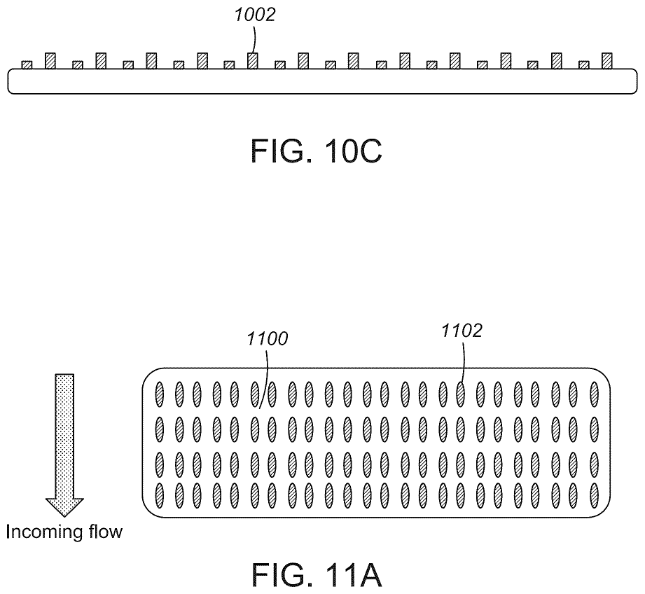

The spacing elements can be a variety of shapes. By way of example, the spacing elements can be circles, ovals, air foils, triangles, rhombuses, rectangles, squares, parallelograms, trapezoids, kites, trapeziums, teardrops, pentagons, heptagons, octagons, hexagons, and the like. For example, referring now to FIG. 10A, a top-down view of a spacing elements layer is shown in accordance with various embodiments herein. Circular spacing elements 1002 can be disposed in columns on spacing media 1000. In some embodiments, the circular spacing elements 1002 can have the same circumference. In other embodiments, the circular spacing elements 1002 can have varying circumferences. For example, the circular spacing elements 1002 disposed at or near the top of spacing media 1000 can be larger than the circular spacing elements 1002 disposed at or near to the bottom of the spacing media 1000. Without being bound by theory, it is believed that arranging the spacing elements in a gradient can help to maximize the flux and loading that can occur in the filtration device. In some embodiments, the circular spacing elements 1002 can be the same height as shown in FIG. 10B, a side view of a spacing elements layer is shown in accordance with various embodiments herein. In other embodiments, the circular spacing elements 1002 can have varying heights as shown in FIG. 10C, a side view of a spacing elements layer is shown in accordance with various embodiments herein. In some embodiments, the circular spacing elements 1002 can be symmetrically distributed on the spacing media 1000. In other embodiments, the circular spacing elements 1002 can be unsymmetrically distributed on the spacing media 1000.

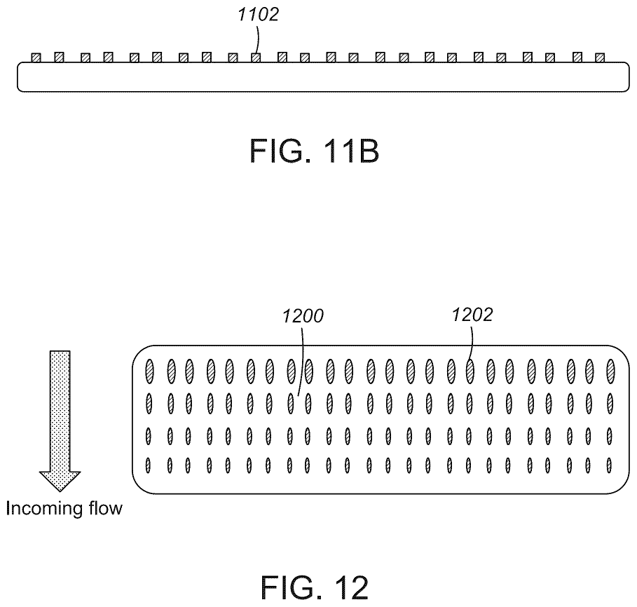

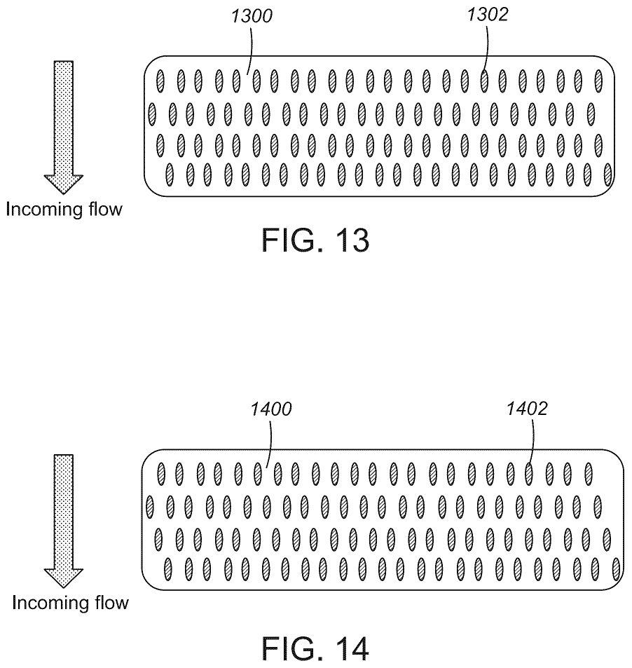

In some embodiments the spacing elements can be an oval shape. Oval shaped spacing elements can be beneficial as the symmetrical shape can reduce turbulence and particle loading in both the forward and reverse fluid flow directions. FIG. 11A, shows a top-down view of a spacing elements layer in accordance with various embodiments herein. Oval spacing elements 1102 can be disposed in columns on spacing media 1100. Referring now to FIG. 11B, a side view of a spacing elements layer is shown in accordance with various embodiments herein. As shown the oval spacing elements 1102 can be the same height. In some embodiments, the oval spacing elements 1102 can have similar sizes and can be disposed on spacing media 1100 in a manner similar to that described above with respect to FIG. 10A. For example, FIG. 12, shows a top-down view of a spacing elements layer in accordance with various embodiments herein. As shown in FIG. 12, the oval spacing elements 1202 disposed at or near the top of spacing media 1200 can be larger than the oval spacing elements 1202 disposed at or near to the bottom of the spacing media 1200. Alternatively, the oval spacing elements 1302 can be disposed on the spacing media 1300 such that the oval spacing elements 1302 are offset from each other as shown in FIG. 13, a top-down view of a spacing elements layer in accordance with various embodiments herein. In other embodiments, the oval spacing elements 1402 can be disposed on the spacing media 1400 in diagonal columns as is shown in FIG. 14, a top-down view of a spacing elements layer is shown in accordance with various embodiments herein.

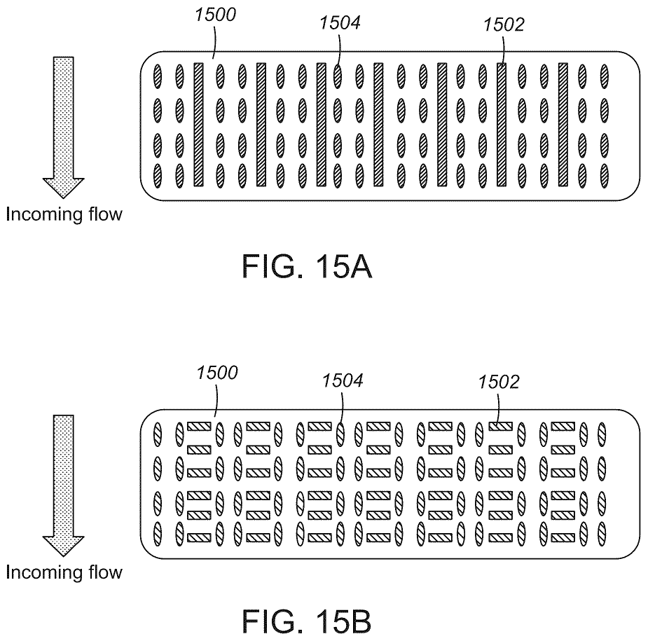

The spacing media can include one or more spacing elements shapes. For example, referring to FIG. 15A, a top-down view of a spacing elements layer is shown in accordance with various embodiments herein. In some embodiments, spacing media 1500 can include two spacing element shapes. As shown, the spacing media 1500 can include oval spacing elements 1504 and rectangular spacing elements 1502. Rectangular spacing elements 1502 can serve to provide structural support to the spacing media 1500 when the spacing media 1500 is wound up. Providing structural support to the spacing media 1500 can help to keep the channels created open and prevent channel collapse, especially on the downstream side of the filtration device. By way of example, the oval spacing elements 1504 at or near the bottom of the spacing media 1500 can be supported by the rectangular spacing elements 1502 when wound up. FIG. 15B, shows a schematic view of a spacing elements layer in accordance with various embodiments herein. FIG. 15B, shows what the backside of spacing media 1500 would look like when the spacing media 1500 is wound up.

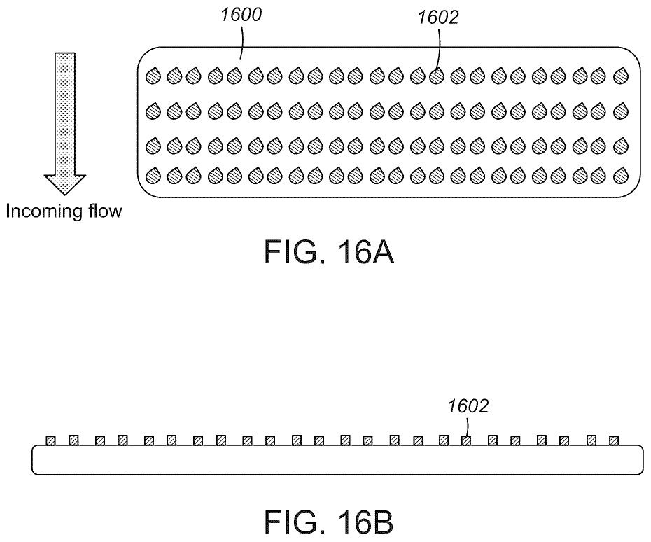

In some embodiments, the spacing elements can be teardrop shaped. Teardrop shaped spacing elements can be beneficial to maintain pressure throughout the filtration device and help release particles with the filtration device is backflushed. Referring now to FIG. 16A, a top-down view of a spacing elements layer in accordance with various embodiments herein. Teardrop spacing elements 1602 can be disposed in columns on spacing media 1600. In some embodiments, the teardrop spacing elements 1602 can have the same length and width. In other embodiments, the teardrop spacing elements 1602 can have varying lengths and widths. For example, the teardrop spacing elements 1602 disposed at or near the top of spacing media 1600 can be larger than the teardrop spacing elements 1602 disposed at or near to the bottom of the spacing media 1600. Referring now to FIG. 16B, a side view of a spacing elements layer is shown in accordance with various embodiments herein. As shown the teardrop spacing elements 1602 can be the same height. In other embodiments, the teardrop spacing elements 1602 can have varying heights. In some embodiments, the teardrop spacing elements 1602 can be disposed on the spacing media 1600 in a manner similar to that described above with respect to FIG. 10A.

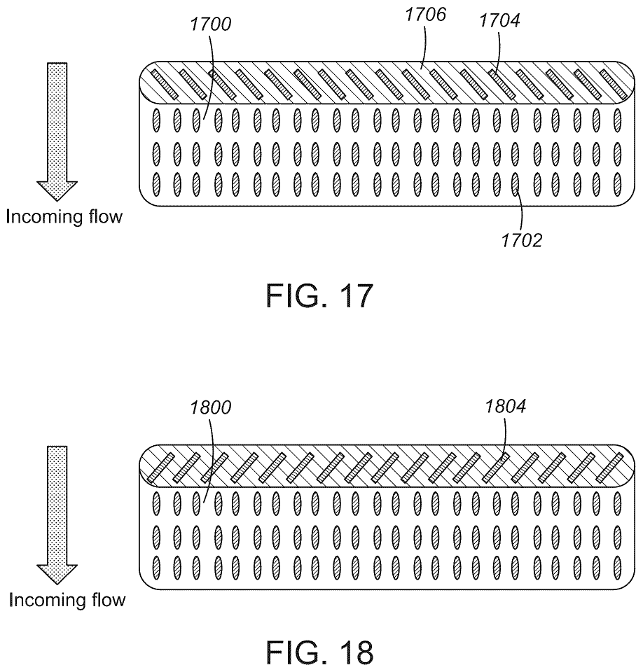

In various embodiments, the spacing elements layer can include differently shaped spacing elements in the seam area of the spacing elements layer. It will be appreciated that spacing elements in the seam area having a different shape than the rest of the spacing elements in the spacing media can help prevent the spacing elements from nesting with a second spacing elements layer when the layers of the filtration device are wound up. Referring now to FIG. 17, a top-down view of a spacing elements layer is shown in accordance with various embodiments herein. Oval spacing elements 1702 can be disposed in columns on the spacing media 1700 while left-slanted rectangular spacing elements 1704 can be disposed on the spacing media 1700 at the seam 1706. In other embodiments, right-slanted rectangular spacing elements 1804 can be disposed on the spacing media 1800, as shown in FIG. 18, a top-down view of a spacing elements layer is shown in accordance with various embodiments herein.

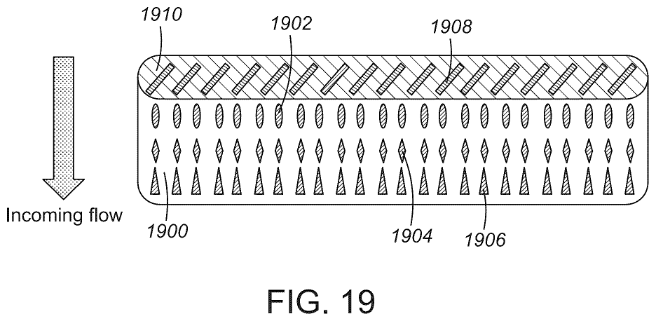

In various embodiments, a plurality of spacing element shapes can be utilized in the spacing media. Referring now to FIG. 19, a top-down view of a spacing elements layer is shown in accordance with various embodiments herein. As shown, spacing media 1900 can include oval spacing elements 1902, rhombus spacing elements 1904, and triangular spacing elements 1906. In addition, rectangular spacing elements 1908 can be disposed in the seam area 1910 of the spacing media 1900. Including a plurality of shapes in the spacing media 1900 may be advantageous to improve the structure of the spacing elements layer or overall filtration device (not device). Additionally, including a plurality of shapes can help improve the overall performance of the filtration device.

### 3D Printing Process for Forming Spacing Elements

The spacing elements described herein can be formed using the process of additive manufacturing, referred to herein as three-dimensional (3D) printing, directly onto a membrane. The spacing elements generated using 3D printing can include structure geometry that is not possible using other manufacturing techniques, including those having a high aspect ratio.

Material handling is also reduced when spacing elements are formed directly onto a membrane or filtration media.

### Materials for Spacing Elements

The spacing elements layer can be made from various materials that are chemically compatible with the membrane layers. For example, the spacing elements layer can be made from polymer, metal, composite, and the like. For example, the spacing elements layer can include UV curing epoxies, UV curing urethanes, and silicone polymers. For example, the materials can include, but are not to be limited to, polydimethylsiloxane (PDMS) and UV curing PDMS. The materials can include, but are not to be limited to, thermoplastic polymers including, but not to be limited to polyamides, polypropylene, polyurethane, polyethylene, polylactic acid, acrylonitrile butadiene styrene, styrene, and co-polymers, mixtures, or derivatives thereof.

It will be appreciated that the spacing elements can be constructed of a variety of materials that can withstand a range of pressures, temperatures, and chemical conditions in the environments in which they are used in operation. The spacing elements can further be constructed of materials that are at least as strong as the filter media or membrane that they are deposited onto.

Additives including chemical additives and particulate additives can be included in the material of the spacing elements. The additives can inhibit fouling, inhibit bio-growth, act as sorbents, catalyze reactions, act as chemical handles for further functionalization, or serve two or more of these functions.

### Methods of Assembling a Filtration Device

Many different methods are contemplated herein, including, but not limited to, methods of making, methods of using, and the like. Aspects of the filtration device described elsewhere herein can be performed as operations of one or more methods in accordance with various embodiments herein.

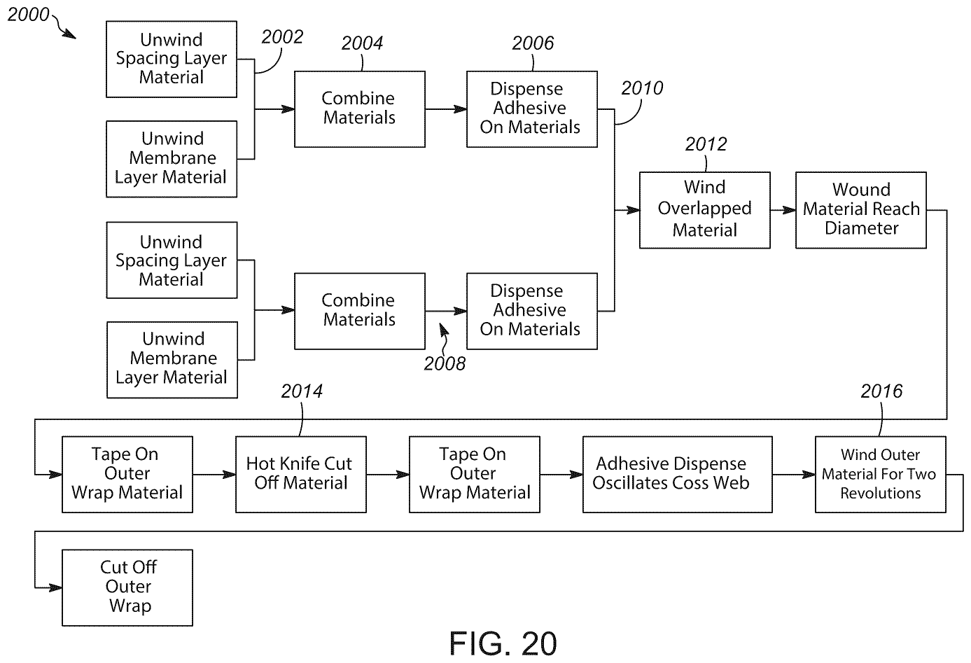

Referring now to FIG. 20, a flow chart showing a method 2000 of preparing a spiral wound filtration device according to an embodiment. In some embodiments, the method 2000 can be performed by a machine. In other embodiments, the method 2000 can be performed by hand.

In some embodiments, the method 2000 can include unwinding membrane material and spacing layer 2002. In some embodiments, the membrane material can be unwound using a cantilever. In some embodiments, the unwinding device can alert a user that the membrane material is running low and needs to be replaced. In some embodiments, the spacing layer material can include a spacing element layer. In other embodiments, the spacing layer material can include a spacing screen.

In some embodiments, the method 2000 can include combining the unwound membrane material and the unwound spacing layer material 2004. In some embodiments, combining the unwound membrane material and unwound spacing layer material can include overlapping the materials such that the edges of each are aligned.

In some embodiments, the membrane material can include spacing elements on one or both sides of the membrane material.

In some embodiments, the method 2000 can include dispensing an adhesive, described in more detail above, on the overlapped materials 2006. In some embodiments, the adhesive can be dispensed on a portion of the overlapped materials. For example, the adhesive can be applied to both widths and lengths of overlapped materials. In some embodiments, the adhesive can be applied approximately one inch from the edges of the overlapped materials. In some embodiments, the machine can be programmed to shut off after a sufficient amount of adhesive has been applied.

In some embodiments, the method 2000 can include repeating the steps above to create a second set of overlapped materials 2008.

In some embodiments, the method 2000 can include combining the first set of overlapped materials and the second set of overlapped materials 2010. In some embodiments combining the first set of overlapped materials and the second set of overlapped materials can include overlapping the sets such that edges of each are aligned. It is noted that when the sets of materials are overlapped the lengths of overlapped materials having adhesive should not be overlapped.

In some embodiments, the method 2000 can include winding up the sets of overlapped materials 2012. In some embodiments, the overlapped materials can be wound around a core positioned lengthwise along a width of the overlapped materials. In some embodiments, the overlapped material can be wound up in a spiral. In some embodiments, the overlapped material can be wound until a desired diameter of the spiral is obtained.

In some embodiments, the method 2000 can include using a hot knife to cut the wound material layers once the desired diameter is obtained 2014. In other embodiments, scissors can cut the wound material layers.

In some embodiments, the method 2000 can include winding an outer wrap around the wound material layers 2016. In various embodiments, the outer wrap can include a membrane layer soaked with adhesive. In some embodiments, the outer wrap, also referred to as an impermeable wrap, can be wound around the wound material layers for one or more revolutions. For example, the outer wrap can be around the wound material layers for two revolutions.

### EXAMPLES

### Example 1: Effects of Spacing Layer Thickness on Membrane Surface Area

A spacing layer having a thickness of 320 microns and a spacing layer having a thickness of 640 microns were compared to a current Donaldson Company LifeTec™ filter on the market, which has a pleated construction, using modeling.

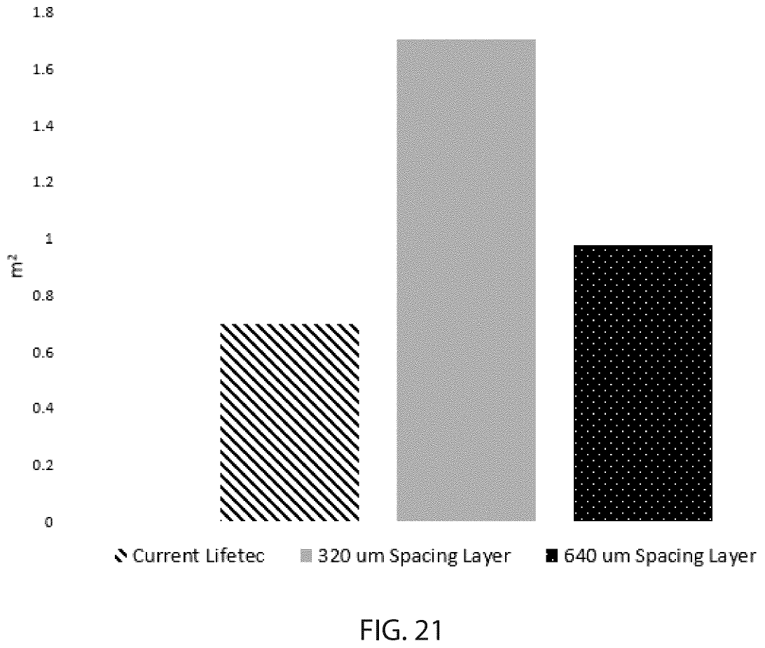

Referring to FIG. 21, a graph showing the effect of spacing layer thickness on membrane surface area is shown according to an embodiment. FIG. 21 illustrates that when spacing layers having a thickness of 320 microns and 640 microns are used in filtration devices, the overall surface area of the membrane surface area increases compared to the LifeTec™ on the market.

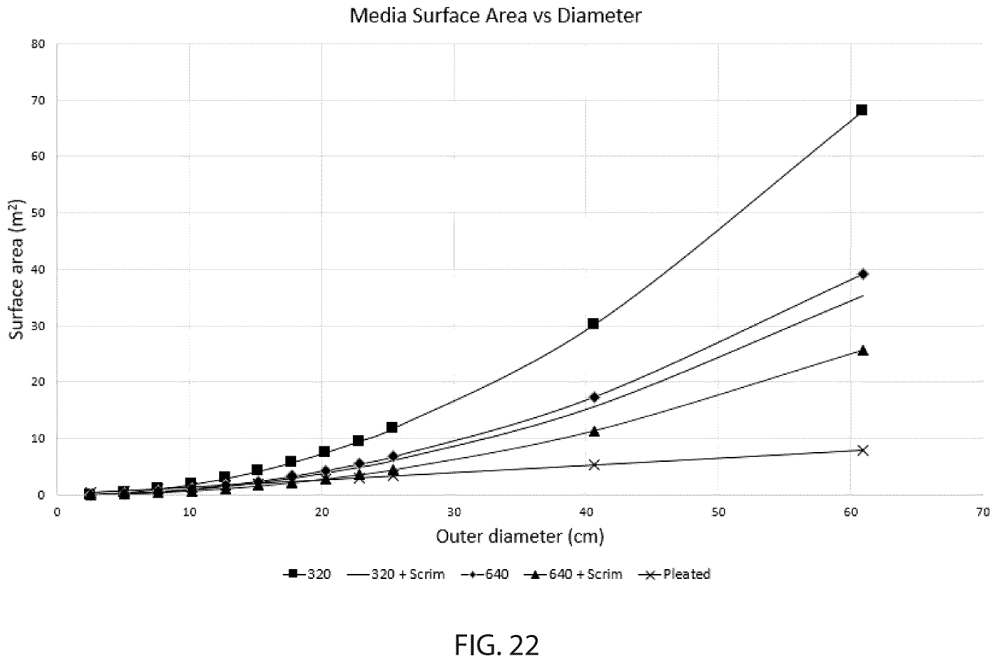

Referring to FIG. 22, a graph showing the effect of spacing layer thickness on membrane surface area is shown according to an embodiment. FIG. 22 illustrates that as the outer diameter of the filtration device layers increases, the surface area of the membrane increases. Specifically, when a spacing layer having a thickness of 320 microns is utilized, the surface area of the membrane is approximately nine times greater compared to that of the LifeTec™ filter. When a spacing layer having a thickness of 640 microns is utilized, the surface area of the membrane is approximately six times greater compared to that of the LifeTec™ filter.

### Example 2: Effect of Number of Spacing Layers on Pressure Drop of the Filtration Device

The effect of one spacing layer on the pressure drop experienced by the filtration device was compared to two spacing layers.

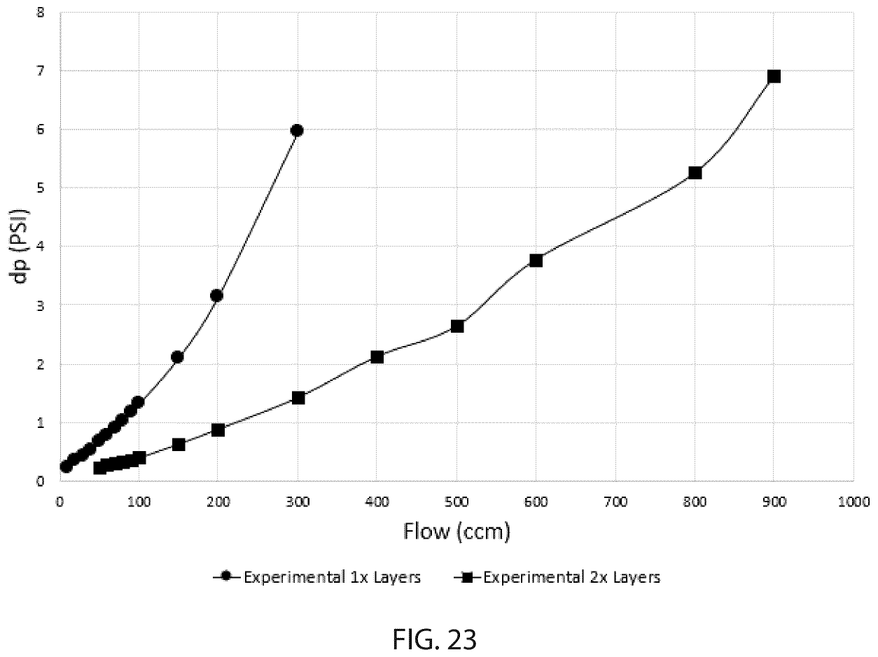

Referring now to FIG. 23, a graph showing the effects of the number of spacing layers on pressure drop is shown according to an embodiment. The graph illustrates that one spacing layer causes a significant increase in differential pressure at lower flow volumes compared to two spacing layers.

### Example 3: Effect of Spacing Layer Dimensions on Pressure Drop of the Filtration Device

The effect of the dimensions of the spacing layer on the pressure drop experienced by the filtration device was compared.

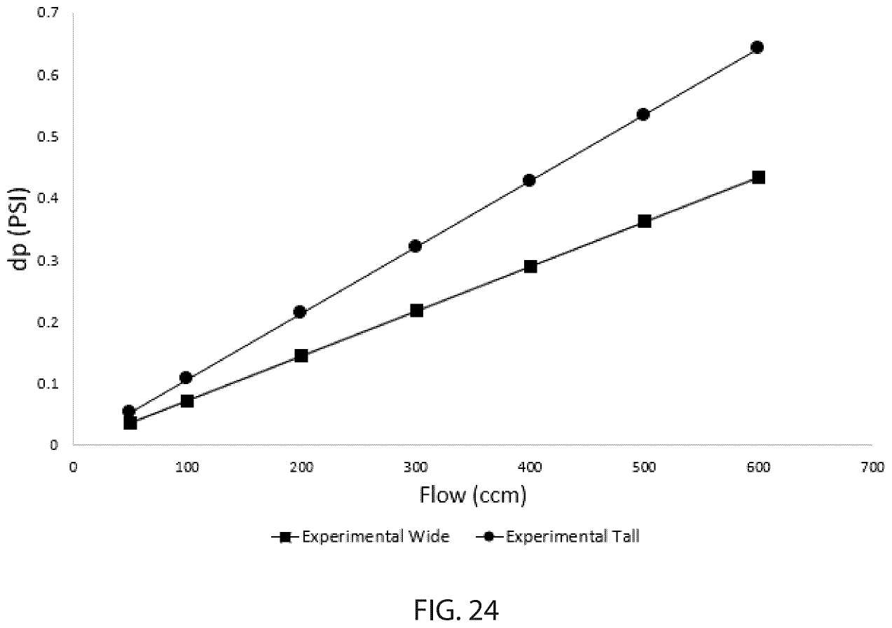

Referring now to FIG. 24, a graph showing the effects of the dimensions of spacing layers on pressure drop is shown according to an embodiment. The graph illustrates that a spacing layer (“Experimental Wide”) being 1.4 inches tall and 3 inches wide experienced lower differential pressure compared to a spacing layer (“Experimental Tall”) being 3 inches tall and 1.5 inches wide.

### Example 4: Model Effects of the Membrane Length on Pressure Drop and Flux

The effects of the length of the membrane layer length on the pressure drop experienced was modeled.

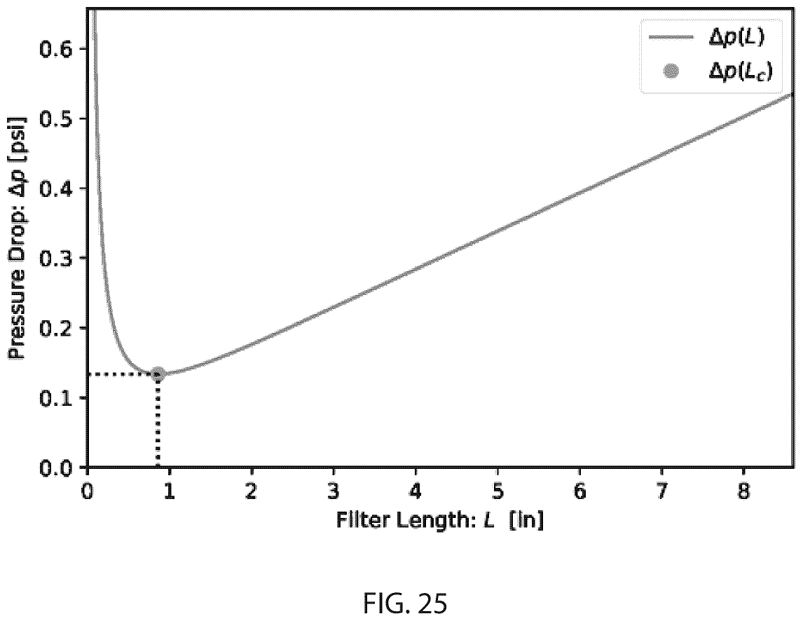

Referring now to FIG. 25, a graph showing the effects of wound membrane layer length on pressure drop is shown according to an embodiment. The graph illustrates that after one inch, as the length of the wound membrane layer increases the pressure drop experienced increases.

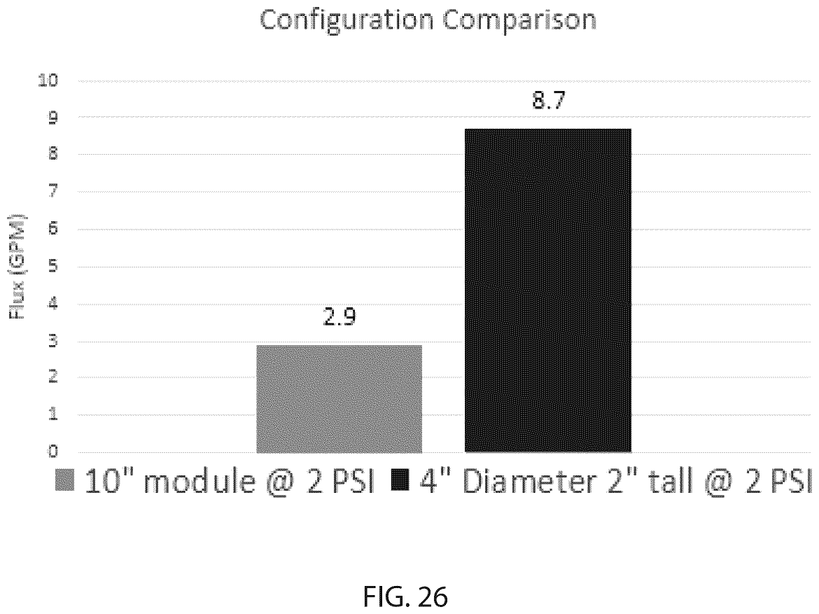

Referring now to FIG. 26, a graph showing the effects of wound membrane length on flux is shown according to an embodiment. The graph illustrates that a shorter four inch in diameter and two-inch-tall membrane filter experiences a much greater flux compared to a 10-inch membrane filter.

### Example 5: Effects of Element, Core, and Spacing Screen Dimensions on Various Properties

Device membrane surface area for specific applications can be determined by flat sheet testing of application fluid if a targeted terminal pressure drop is known. Flat sheet testing will determine the base membrane performance. If the desired application volume of fluid to be filtered is known, the amount of membrane surface area that the filter would have is proportional to the amount of fluid the flat sheet was able to filter.
SA_{pred}=Predicted Membrane Surface area
SA_{FS}=Flat sheet membrane surface area
V_{FS}=Volume of Fluid to terminal pressure drop in flat sheet test
Vₐₚₚ=Target Application volume to be filtered

$$S {A}_{Pred} = \frac{S {A}_{F S}}{{V}_{F S}} * {V}_{a p p}$$

This information can be used to determine the outer diameter of the element when desired height, membrane thickness, screen thickness, and core diameter are known.

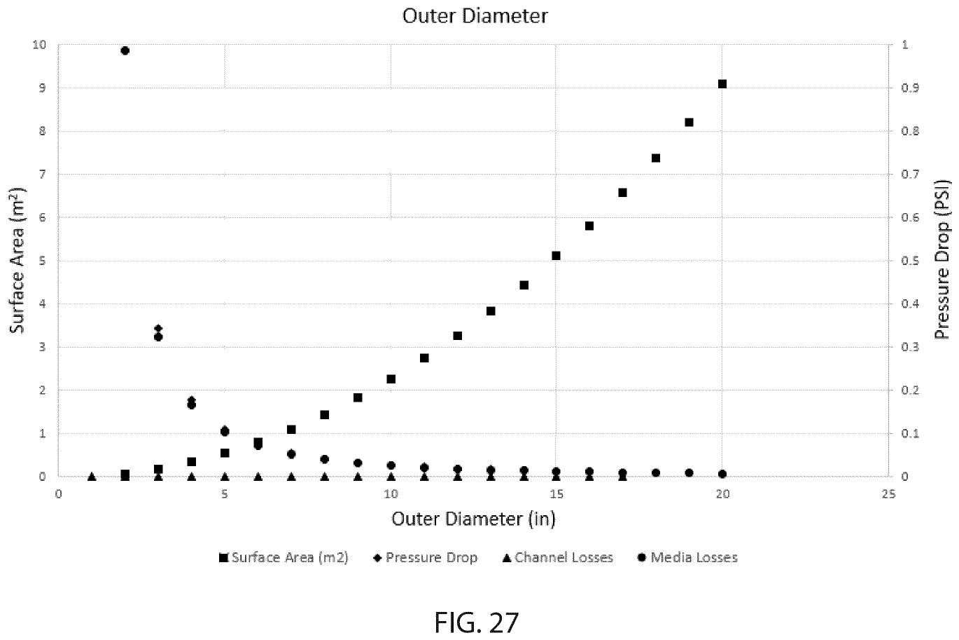

Referring to FIG. 27, a graph showing the effects of the elements diameter on several properties is shown according to an embodiment. The graph illustrates that as the element diameter increases, the pressure drop, media loss, and channel loss decrease while the membrane surface area increases.

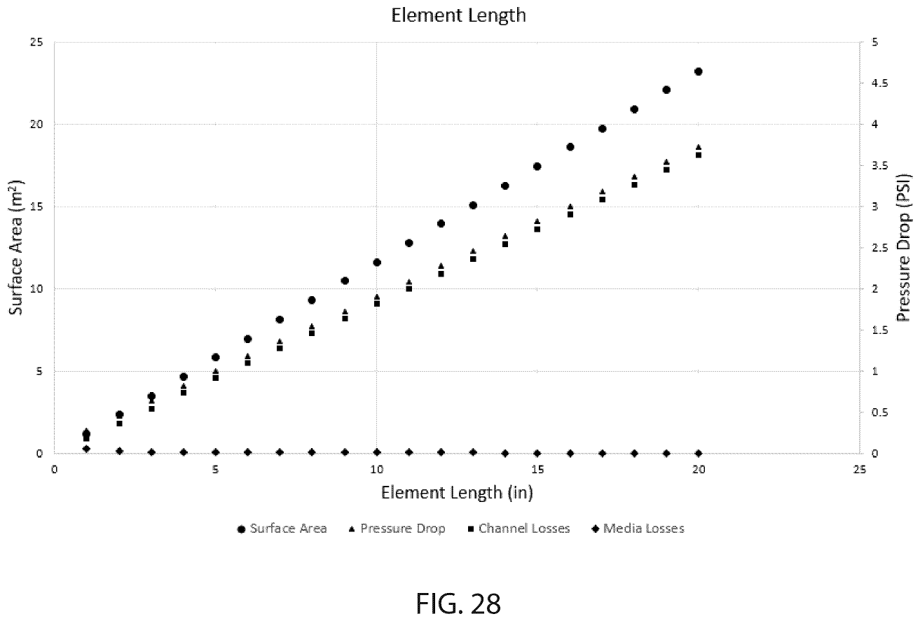

Referring to FIG. 28, a graph showing the effects of the elements length on several properties is shown according to an embodiment. The graph illustrates that as the element length increases, the pressure drop, channel loss, and surface area increases while the media loss decreases.

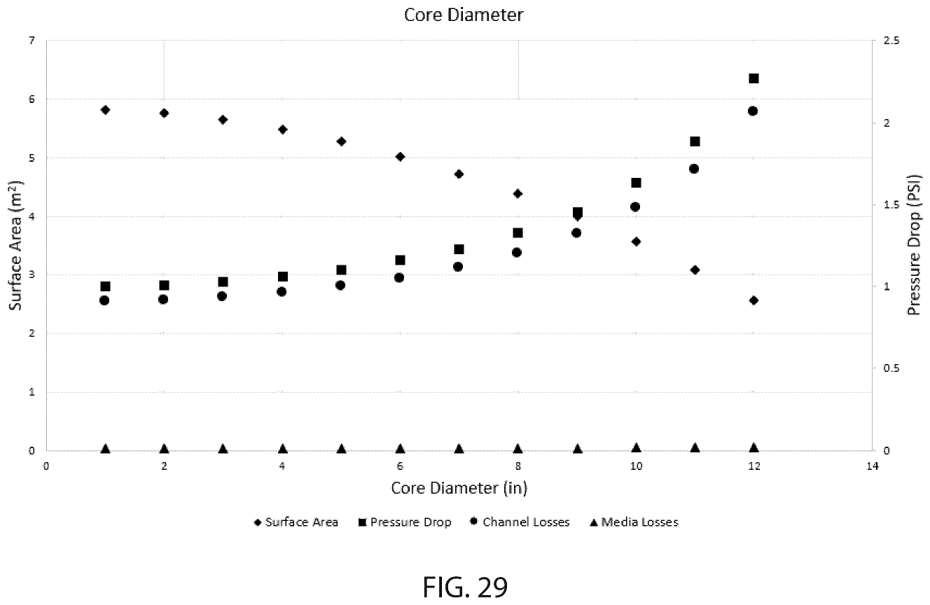

Referring to FIG. 29, a graph showing the effects of the core diameter on several properties is shown according to an embodiment. The graph illustrates that as the core diameter increases, the pressure drop and channel loss increases, the membrane surface area increases, and the media loss stays approximately the same.

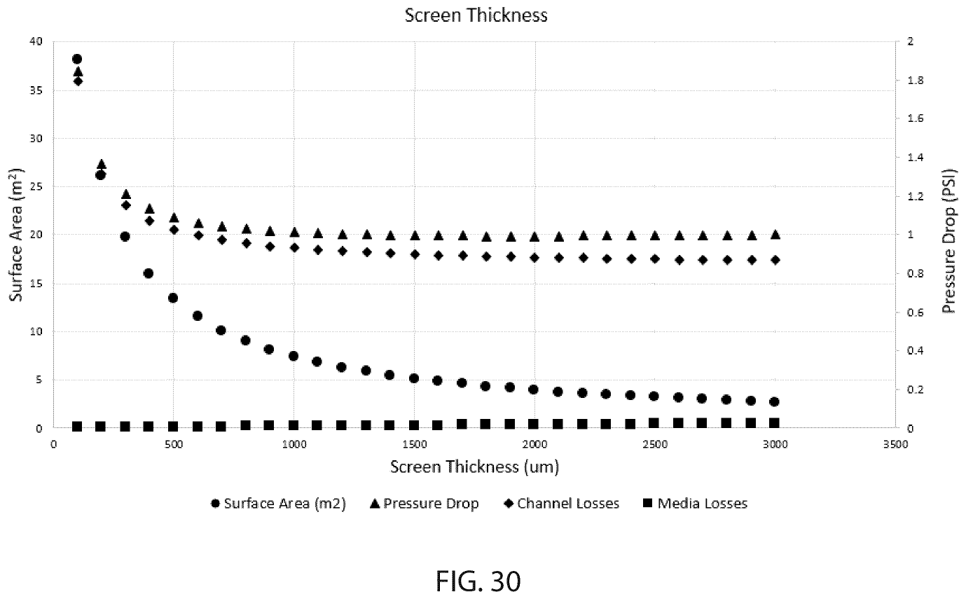

Referring to FIG. 30, a graph showing the effects of the spacing screen thickness on several properties is shown according to an embodiment. The graph illustrates that as the spacing screen thickness increases, the membrane surface area and channel loss decrease while the pressure drop and media loss increases.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

The claims are:

1. A filtration device comprising:
a first spiral wound filter element comprising:
one or more spacing layers;
one or more membrane layers disposed in between the one or more spacing layers; and
a plurality of spacing elements;
wherein the aspect ratio of the first spiral wound filter element is less than 8:1 height to width.

2. The filtration device of claim 1, further comprising a second, third, and fourth spiral wound filter element, wherein the second, third, and fourth spiral wound filter elements each comprise:
one or more spacing layers;
one or more membrane layers disposed in between the one or more spacing layers; and
a plurality of spacing elements;
wherein the aspect ratio of the second, third, and fourth spiral wound filter elements are less than 8:1 height to width.

3. The filtration device of claim 2, further comprising a fifth, sixth, seventh, and eighth spiral wound filter element, wherein the fifth, sixth, seventh, and eighth spiral wound filter elements each comprise:
one or more spacing layers;
one or more membrane layers disposed in between the one or more spacing layers; and
a plurality of spacing elements;
wherein the aspect ratio of the fifth, sixth, seventh, and eighth spiral wound filter elements are less than 8:1 height to width.

4. The filtration device of claim 2, further comprising a first stack comprising of the first, second, third and fourth spiral wound filter elements placed in parallel.

5. The filtration device of claim 3, further comprising a first stack comprising the first, second, third and fourth spiral wound filter elements placed in parallel, further comprising a second stack comprising the fifth, sixth, seventh, and eighth spiral wound filter elements placed in parallel.

6. The filtration device of claim 5, wherein the first stack and the second stack are placed in series.

7. The filtration device of claim 1 having a height between two and ten inches.

8. The filtration device of claim 1 having a diameter between 5 to 40 inches.

9. The filtration device of claim 1, further comprising one or more supporting layers disposed in between the one or more membrane layers and the one or more spacing layers.

10. The filtration device of claim 1, wherein the plurality of spacing elements comprises a variety of shapes comprising one or more of the following: air foils, triangles, rhombuses, parallelograms, trapezoids, kites, trapeziums, pentagons, heptagons, octagons, hexagon, circles, ovals, squares, rectangles, and teardrops.

11. The filtration device of claim 10, wherein the plurality of spacing elements comprises an airfoil shape.

12. The filtration device of claim 1, wherein the plurality of spacing elements is arranged in a size gradient.

13. The filtration device of claim 1, wherein the plurality of spacing elements is unsymmetrically distributed.

14. A filtration device comprising:
a spiral wound filter element comprising:
one or more spacing screens having flow direction fibers and cross flow direction fibers, wherein the flow direction fibers are approximately oriented in the flow direction of a fluid entering the spiral wound filter element; and
one or more membrane layers disposed in between the one or more spacing screens.

15. The filtration device of claim 14 having an aspect ratio of less than 8:1 height to width.

16. The filtration device of claim 14, wherein the flow direction fibers and the cross flow direction fibers comprise a variety of shapes comprising one or more of the following: circular, polygonal, oval, lima bean shaped, triangular, trilobal, lobular, mushroom shaped, dog-boned shaped, ribbon-shaped, star shaped, and tubular.

17. The filtration device of claim 14, wherein the flow direction fibers are 100 to 500 microns large.

18. The filtration device of claim 14, wherein the cross flow direction fibers are 50 to 300 microns large.

19. The filtration device of claim 14, wherein the flow direction fibers are larger than the cross flow direction fibers.

20. The filtration device of claim 14, wherein the one or more spacing screens have between 10 and 90 percent open area.
